(19) United States
(12) Patent Application Publication
(10) Pub. No.: US 2005/0154769 A1
(43) Pub. Date: Jul. 14, 2005

(54) Systems and methods for benchmarking business performance data against aggregated business performance data

(75) Inventors: Loren Eckart, Atlanta, GA (US); Robert Woosley, Atlanta, GA (US)

Correspondence Address: HUNTON & WILLIAMS;Suite 1200, 1900 K Street, N.W., Washington, DC, 20006-1109, US

(73) Assignee: llumen, Inc., Atlanta, GA (US)

(21) Appl. No.: 10/999,101

(22) Filed: Nov. 30, 2004

Related U.S. Application Data
(63) Continuation-in-part of application No. 10/830,115, filed on Apr. 23, 2004.
(63) Continuation-in-part of application No. 10/893,495, filed on Jul. 19, 2004.
(60) Provisional application No. 60/535,801, filed on Jan. 13, 2004.

(51) Int. Cl. G06F 17/30

(52) U.S. Cl. 707/201

(57) ABSTRACT

An automated system for allowing a submitter business to benchmark its business performance information, including operational data against aggregated business performance information of private company industry peers through a business performance information benchmarking data center computer system over the Internet.

### CROSS REFERENCE TO RELATED APPLICATIONS

This application is a continuation-in-part of related application Ser. No. 10/893,495, filed Jul. 19, 2004, entitled, “Systems and Methods for Selective Sharing of Business Performance Information,” which in turn is a continuation-in-part of related application Ser. No. 10/830,115, filed Apr. 23, 2004 entitled, “Automated Management of Business Performance Information,” the disclosures of which are both hereby incorporated by reference in their entirety.

### FIELD OF THE INVENTION

The present invention relates generally to automated processing of business performance information and more particularly to an automated business performance data management system for permitting businesses who participate in a benchmarking service to benchmark their business performance information against aggregate averaged business performance information of multiple businesses.

### BACKGROUND OF THE INVENTION

Business performance information has become extremely important in today's competitive business marketplace in measuring a company's performance versus its competitors, peers, the industry, etc. Businesses of all types have a need to monitor their own business performance information and compare it against that of other similar businesses when making important business decisions. The ability to access timely, accurate and standardized business performance information from a peer group of companies can provide invaluable insight to the inquiring business when making financial and operating decisions. The ability to do so allows businesses to understand the effectiveness of current business strategies, rank themselves within the industry, make predictions about future business performance, assess risk and vulnerability, and make other important business decisions.

Benchmarking, is one way for businesses to compare their businesses' performance relative to other peer companies in the same industry. Benchmarking, as conventionally understood, is the process of comparing business performance data attributes or metrics of a particular company against data for one or more other business, usually aggregated data of multiple businesses that are similarly situated, in order to gain an understanding of how the business is performing relative to other businesses for the particular attributes or metrics. For example, in one instance, a company may desire to benchmark its gross profit margins against gross profit margins in the industry to determine whether its profit margins are the same, less than or more than its competitors. In another instance, a company may desire to benchmark its revenues against revenues in the industry for similarly-sized companies in the same industry. It is possible to imagine infinite ways a company may want to benchmark its business performance information against information for segments of the industry in which its is operating as a means of learning its relative performance in various business performance categories or metrics.

In order for benchmarking to be meaningful and effective, that is to provide an accurate picture of how a business is performing relative to other similarly situated businesses, sufficient control must be maintained over the data used for comparison. For example, the information used in benchmarking must be for the same time period(s) being compared against, that is apples to apples. Comparing data of a company for one period against aggregated industry data of another period is less meaningful than same period comparisons. Also, data used in benchmarking should be sufficiently recent. While there may be some value in making historic comparisons dating back in time years or more, more meaningful analysis is usually based on current, that is at least the current year's business performance reporting period. Due to the dynamic nature of markets, data that is old may not provide an accurate means of comparison under current market conditions.

Another important aspect of benchmarking is that if aggregate and/or averaged data is used, it must include information from a sufficiently large number of companies within the industry in order to provide an accurate measure of performance within the industry. This number will vary from industry to industry depending on the nature of the industry itself. Yet another important aspect of benchmarking is standardization. In order to effectively benchmark a company's business performance data against data of other businesses, the data sets must all be of the same format. This affects not only the ease of comparison, but also the meaningfulness of the comparison to the extent that each contributing company should ideally be contributing the same kind of data such as, for example, data taken from the same type of financial report.

Business performance information on publicly traded companies is easily obtainable due to the standardization of financial record keeping in accordance with generally accepted accounting principles (GAAP) and quarterly and annual filing and disclosure requirements imposed by the U.S. Securities and Exchange Commission (SEC). Therefore, it is relatively easy to insure that the data is accurate, standardized, timely and inclusive of a sufficiently large number of industry members. Business performance information on publicly traded companies gleaned from quarterly and annual filings is available for free from web sites such as YAHOO Finance, among others. Anyone with an Internet connection and a web browser can log into sites such as YAHOO Finance and perform benchmarking for a particular public company against data for other public companies in that industry.

However, for partnerships and other private business ventures, obtaining timely, accurate, and standardized financial information is much more difficult. Private businesses typically maintain their own financial records, either on site or through the assistance of an outside accountant firm, and use one of a number of commercial off the shelf (COTS) financial accounting software programs. Such software programs include but are not limited to, QUICKBOOKS, SOLOMON, and PEACHTREE and are ubiquitously well known in the accounting profession. All of these programs, in one form or another, maintain financial records including balance sheets, income statements, individual account statements and other well known financial records which can be generally classified as business performance information. The financial records for a business typically are divided into a number of financial accounts represented in a general ledger. The accounts may be grouped by class, subclass, and so on. Absent strict guidelines or regulations, the definition and use of these accounts is relatively fluid and may be arranged according to the classifications used by a particular business. For example, while one business may desire to lump all liquid assets into a general financial account “cash & cash equivalents,” it may be more suitable for another business to classify liquid assets by a number of separate accounts, such as, for example, a “cash” account, a “short term investments” account, and an “other” account. As another example, manufacturers often make use of the “cost of goods sold (COGS)” account, while this financial account may be unnecessary in certain service-oriented businesses. Recognizing this need for flexibility in organizing financial information, COTS accounting software programs often allow users to customize various financial accounts and subaccounts and to organize their financial information according to their needs and interests. Therefore, business performance information for private companies may be organized according to widely divergent formats from business to business. Moreover, typically this information is only shared with the company's CPA firm, bank or other underwriter and is not available for consumption by others even in an anonymous aggregate format.

As a result of the decentralized, non-standardized and unreported nature of small or private business financial information, it is often difficult for interested companies to obtain standardized business performance information of other businesses in the same industry for benchmarking purposes. The process of gathering and monitoring business performance information on private businesses has been highly labor intensive and often produced inaccurate results. Typically, information on theses companies is only available through a financial data gathering service, such as Dun & Bradstreet, who prepares and sells company reports summarizing any known financial information about the business of interest. Such a report has come to be known in the profession as a “D & B.” This data can then be aggregated with data from other companies to create a database of data from which to benchmark a private company's business performance data against.

However, a problem with benchmarking against data obtained through this type of financial reporting is that information obtained by financial information gathering firms on private companies is largely obtained through solicitation and surveying of the company itself. Once this self-reported information gets into the information gathering firm's possession, the submitting company no longer has control over its distribution. As a result, companies are generally reluctant to provide full disclosure, and may even be incentivized to mislead other companies seeking to gather information on them. Due to this lack of control over the security of their business performance information, companies are reluctant to share business performance for this purpose.

Another problem with benchmarking against data obtained through conventional private company financial reporting techniques is that because the contributing companies typically have their own user-defined format for maintaining their business performance information, it is difficult to standardize the data from multiple sources to provide a relevant pool of aggregate data. Therefore, the data collection method may be disjointed, consisting of various sources which must be manually assimilated into a format that is valuable to consumers of such information. This is a labor intensive process which increases the ultimate cost for such information, can take a sufficiently long time period so as to render the data outdated and will likely reduce its accuracy, all of which diminish the suitability of data obtained through conventional data gathering processes for benchmarking purposes. Non-standardized data is likely to have diminished usefulness for benchmarking purposes and may ultimate provide meaningless comparisons.

Yet another problem with benchmarking against data obtained through conventional private company financial reporting techniques is that even when benchmarking data is available for a particular industry, the user is typically unable to further refine the data set used for benchmarking. That is, for a particular metric, only a single aggregate averaged value is provided which is derived from all members of the industry contributing to the data. The user is not able to filter the set to limit the businesses contributing to the aggregate averaged data on parameters in addition to business classification code. Thus, for a given industry, there may be factors such as size of business, location of business, number of employees, financial attribute, etc., which can impact the values of business performance metrics for companies within that industry. Including data for all such companies in the aggregate averaged benchmark data may reduce the relevance of the data to a particular company seeking to benchmark its performance information against only similarly situated businesses within an industry.

Still a further problem with benchmarking against data obtained through conventional private company financial reporting techniques is that because of the time involved in data gathering, the data is not always current, and is not periodically updated. Therefore, it is usually not possible to view interim, trended information, such as quarter over quarter information for a given metric.

Accordingly, there is a need for an improved system for obtaining aggregate private company business performance information so that private companies can benchmark their own business performance information against average values of the aggregate business performance information of other similarly situated private companies that ameliorates or overcomes the deficiencies of known systems.

### SUMMARY OF THE INVENTION

In view of the foregoing shortcomings of conventional private company data gathering and benchmarking techniques, various embodiments of this invention provide systems and methods for benchmarking business performance information of a company against business performance information of other companies that mitigates or solves the above-identified limitations in known solutions, as well as other unspecified deficiencies in known solutions.

Various embodiments of the invention may provide a business performance information benchmarking system that invites users to submit their business performance information to be aggregated with business performance information of other businesses for benchmarking purposes.

Various embodiments of the invention may provide a business performance information benchmarking system that maintains business performance data of submitter companies anonymously in a database with business performance information of other submitter companies such that the business performance information of a particular company and/or its identity can not be derived from the aggregated data.

Various embodiments of the invention may provide a business performance information benchmarking system that standardizes business performance information obtained from submitter businesses and adds the standardized information to business performance information of other businesses.

Various embodiments of the invention may provide a business performance information benchmarking system that permits submitters to upload up-to-date business performance information for each reporting period including interim and annual financial data.

Various embodiments of the invention may provide a business performance information benchmarking system that benchmarks a submitter company's business performance information against aggregate business performance information in accordance with one or more business performance metrics.

Various embodiments of the invention may provide a business performance information benchmarking system including an interactive benchmarking dashboard displaying a submitter's business performance information and the benchmarking information of the aggregate business performance information based on classification codes and other parameters set by the submitter.

Various embodiments of the invention may provide a business performance information benchmarking system including a peer group control module allowing a user to filter the businesses whose business performance information contributes to the aggregate business performance information for benchmarking based on one or more user-defined parameters.

Various embodiments of the invention may provide a business performance information benchmarking system including a variance and alerts module that allows a user to define at least one variance threshold for benchmarking results wherein exceeding or failing to exceed the threshold causes an alert to be automatically generated by the system.

To achieve the above noted objectives and in accordance with the purposes of the invention as embodied and broadly described herein, this invention, in one embodiment, provides a method for performing benchmarking of business performance information. The method according to this embodiment comprises generating at least one business performance report based on data associated with a submitter business on a computer system, uploading the at least one business performance report to a data center computer system via a communications network including uploading at least one classification code for the submitter business, converting, using an automated process executed by the data center computer system, the at least one business performance report from a first data format to a second data format, adding data in either the first data format or the second data format to aggregated data for other submitter businesses, and benchmarking information in the second data format against the aggregated data based on the at least one classification code.

In accordance with another exemplary embodiment of this invention, a method for benchmarking business performance data of a submitter business against other aggregated business performance data of businesses in the same industry is provided. The method according to this embodiment comprises generating, with a software program executing on a computer system, at least one business performance report comprising business performance data of a submitter business in a first data format, using a graphical user interface, uploading the at least one report to a data center computer system via the Internet, including uploading at least one classification code for the submitter business, converting, using an automated process executed by the data center computer system, the at least one report from the first data format into a second data format, adding data in either the first data format or the second data format to aggregated data for other submitter businesses, and benchmarking information in the second data format against the aggregated data based on the at least one classification code.

In accordance with yet another exemplary embodiment of this invention, a system for automated benchmarking of a submitter business' business performance information is provided. The system according to this embodiment comprises at least one data center computer system configured to operate at least one Internet web site displaying one or more Internet web pages, receive business performance information associated with a submitter business via data upload of at least one business performance information file from the submitter business over the Internet, the at least one business performance information file formatted in a first data format and including at least one classification code for the submitter business, using software instructions executing on the data center computer system, convert the at least one business performance report from a first data format into a second data format, add data in either the first data format or the second data format to aggregated performance data of other businesses, perform benchmarking of the converted business performance report the based on the at least one classification code, and display the at least one business performance report including results of the benchmarking in the second data format over the Internet to persons authorized by the submitter business.

Yet another exemplary embodiment according to this invention provides, in an environment comprising a plurality of submitter businesses, each submitter business associated with at least one submitter business computer system and each submitter business classified by at least one classification code, and a data center computer system, the at least one submitter business communicating with the data center computer system via a communications network, a system for benchmarking business performance information of a submitter business against aggregated business performance information based on the at least one classification code. The system according to this embodiment comprises a data center computer system comprising means for electronically receiving over a communications network at least one business performance information file associated with a submitter business and at least one classification code for the submitter business, the at least one business performance information file in a first data format, automated means for converting the at least one business performance information file into a second data format, automated means for aggregating data in either the first data format or the second data format with previously stored data for other businesses, automated means for benchmarking data in the second data format against aggregated data for other businesses based on the at least one classification code, and means for selectively displaying information contained in the at least one business performance information file via the communications network based on instructions from the submitter business.

In still a further exemplary embodiment according to this invention, a method for adding submitter businesses to a business performance information benchmarking network is provided. The method according to this embodiment comprises sending an electronic message over a communications network to a business inviting the business to participate in the business performance information benchmarking network, the message including an electronic link to a data center computer system, after selection of the link by a representative of the submitter business, receiving a business performance information file at the data center computer system along with at least one classification code for the submitter business over the communications network, converting data in the business performance information file from a first data format to a second data format, adding data in either the first data format or the second data format to aggregated data from other businesses, benchmarking the data in the second data format against the aggregated data based on the at least one classification code, enabling the business performance data in the second data format including the results of the benchmarking to be viewed via the network based on instructions received from the submitter business.

Still an additional exemplary embodiment according to this invention provides, in a data center computer system, a computer readable storage medium containing computer readable instructions executable by a processor, the instructions configured to enable a submitter business to benchmark business performance information against aggregated business performance information for other businesses in the same industry as the submitter business. The computer readable storage medium according to this embodiment comprises instructions for receiving a data upload comprising a file containing business performance data corresponding to a submitter business in the form of a business performance information file in a first data format including at least one classification code for the submitter business, instructions for converting the business performance data in the business performance information file into a second data format, instructions for adding the business performance data to aggregated business performance data for other businesses, instructions for benchmarking the business performance data in the second data format against the aggregated business performance data based on the at least one classification code, instructions for generating a business performance report including the business performance data in the second data format and the results of the benchmarking, and instructions for displaying the business performance report to the submitter business.

Yet a further embodiment according to this invention provides, in a data center computer system, a computer readable storage medium containing computer readable instructions executable by a processor, the instructions configured to enable a submitter business to benchmark business performance information against aggregated business performance information for other business in the same industry as the submitter business. The computer readable storage medium according to this embodiment comprises instructions for receiving a request to perform benchmarking of a company's business performance data accessible by the data center computer system, instructions for benchmarking the business performance data against aggregated business performance accessible by the data center computer system based on at least one classification code associated with the company, instructions for generating a business performance report including results of the benchmarking, and instructions for displaying the business performance report to the interested party.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic diagram illustrating the components of a network-based business performance benchmarking system according to at least one embodiment of this invention;

FIG. 2 is a flow chart illustrating the steps of a method for benchmarking a submitter business' business performance information against aggregated business performance information according to at least one embodiment of this invention;

FIG. 3, is a graphic image illustrating an exemplary electronic mail message including an invitation to register interest in participating in a network-based business performance benchmarking system according to at least one embodiment of this invention;

FIG. 4 is a graphic image illustrating an exemplary registration screen of a web browser client for registering interest in subscribing to a network-based business performance information benchmarking system according to at least one embodiment of this invention;

FIG. 5 is a block diagram illustrating the flow of services and data to and from the benchmarking system according to at least one embodiment of this invention;

FIG. 6 is a graphic image illustrating an exemplary electronic mail message notifying a company who's interest in benchmarking has been previously registered that benchmarking services are now available, including a link to click-through to the network-based business performance benchmarking system to begin the sign up process according to at least one embodiment of this invention;

FIG. 7 is a graphic image illustrating an exemplary log-in screen of a web browser client for securely logging in to a business performance information benchmarking system according to at least one embodiment of this invention;

FIG. 8 is a graphic image illustrating an exemplary service agreement acceptance screen of a web browser client including the body of the agreement and buttons operable to register an acceptance or rejection of the terms of the agreement according to at least one embodiment of this invention;

FIG. 9 is a is a graphic image illustrating an exemplary business performance information upload browser window for uploading business performance information to a network-based business performance information benchmarking system according to at least one embodiment of this invention;

FIG. 10 is a print out of an exemplary trial balance file in a submitter-defined format for upload to a network-based business performance information benchmarking system according to at least one embodiment of this invention;

FIG. 11 is a graphic image illustrating an exemplary interactive benchmarking dashboard presenting business performance data of a submitter business in conjunction with aggregate business performance data of other businesses in a combined text and graphic format generated by a network-based business performance information benchmarking system according to at least one embodiment of this invention;

FIG. 12 is a graphic image illustrating another exemplary view of an interactive benchmarking dashboard including a graph portion that plots values for a particular metric against an industry average for a user designated time period according to at least one embodiment of this invention;

FIG. 13 is a graphic image illustrating another exemplary view of an interactive benchmarking dashboard including a graph portion plotting values for a particular metric against an industry average as well as top and bottom quartiles for a user designated time period according to at least one embodiment of this invention;

FIG. 14 is a graphic image illustrating another exemplary view of an interactive benchmarking dashboard including a peer group control module for specifying one or more adjustable parameters relating to the peer group that is used for benchmarking according to at least one embodiment of this invention;

FIG. 15 is a graphic image illustrating another exemplary view of an benchmarking report accessible through the benchmarking dashboard including a graph portion plotting values for a particular metric against an industry average wherein the members contributing to the industry average have been filtered according to a peer group control module according to at least one embodiment of this invention;

FIG. 16 is a graphic image illustrating an exemplary view of an interactive benchmarking dashboard including a variance and alert module for setting various user-defined variance tolerances of the benchmarking results according to at least one embodiment of this invention; and

FIG. 17 is block diagram illustrating the internal components of a network-based business performance information benchmarking system according to various exemplary embodiments of this invention.

### DETAILED DESCRIPTION OF THE INVENTION

The following description is intended to convey a thorough understanding of the present invention by providing a number of specific embodiments and details involving an automated system for gathering, standardizing, aggregating, analyzing, benchmarking, maintaining and displaying business performance information. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The term “business,” in the context of a submitter of performance information, as used herein and for the purposes of example, will typically be used to refer to a private business venture, including but not limited to a private corporation, partnership or other business entity. For the purposes of this specification and claims, businesses are the submitters of financial information to the business performance information benchmarking network. However, it should be appreciated that the present invention may also be applicable to public corporations and/or non-for-profit organizations, government organizations and quasi-government organizations. That is, any of these entities may be submitter businesses as well. Also, the submitter may be an entity in possession of business performance information of many businesses, such as a financial institution, a CPA firm or a corporation.

As used herein, the terms “data” and “information” may be used interchangeably to refer generally to business performance data and/or operational data irrespective of format. That is any information that characterizes a business, either for a single business or as aggregated in the benchmarking system according to various embodiments of the present invention.

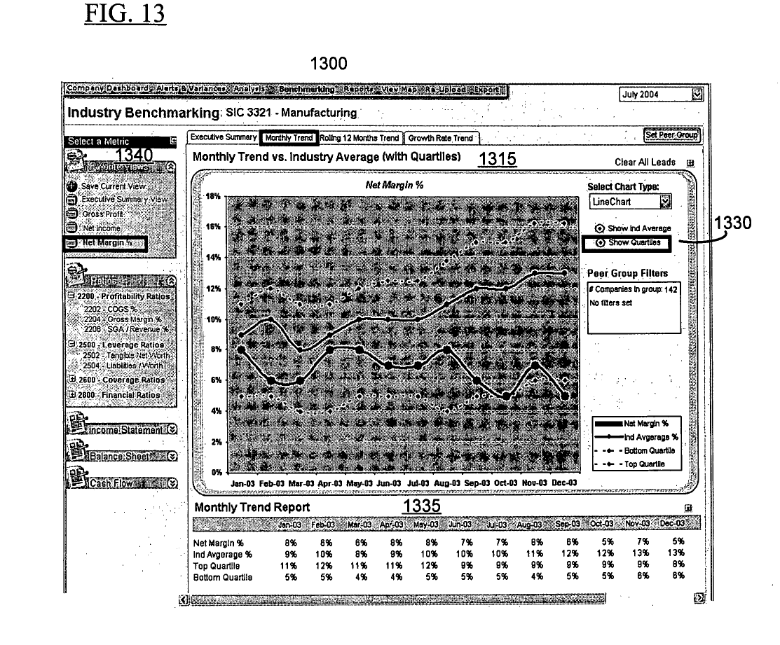

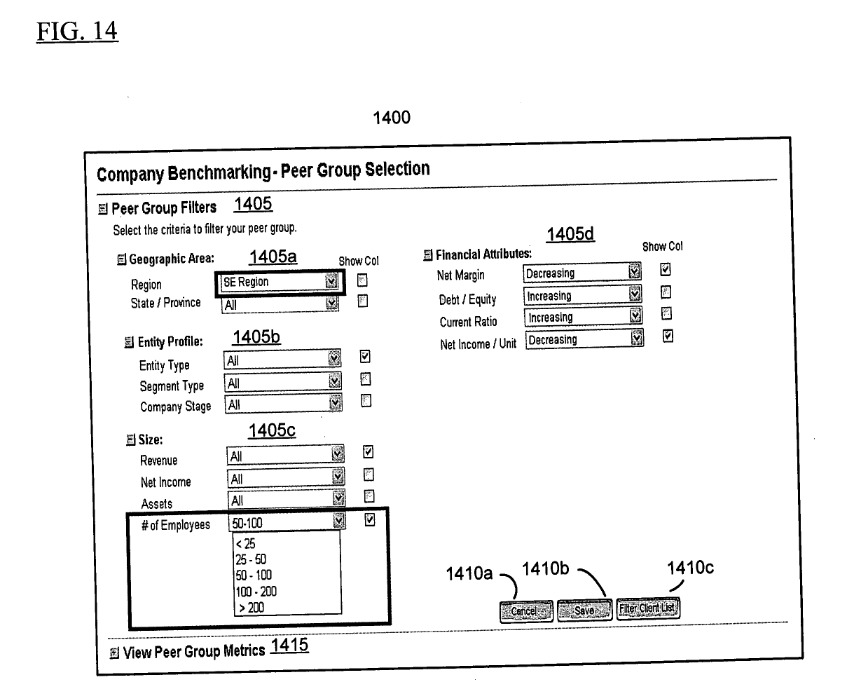

Though throughout this disclosure aggregated business performance data is frequently discussed in the context of aggregated average business performance data, it is important to note that in certain instances it may be desirable for a submitter company to benchmark its business performance information against the industry as a whole, rather than against the industry average. For example, the submitter may want to see a pie chart showing its revenue as a percentage of revenue within the industry. This type of benchmarking analysis is within the scope of this invention. Furthermore, though the specification predominantly refers to benchmarking against aggregate averaged data, the data could be either median data or quartile data, such as, for example, as shown in FIG. 13.

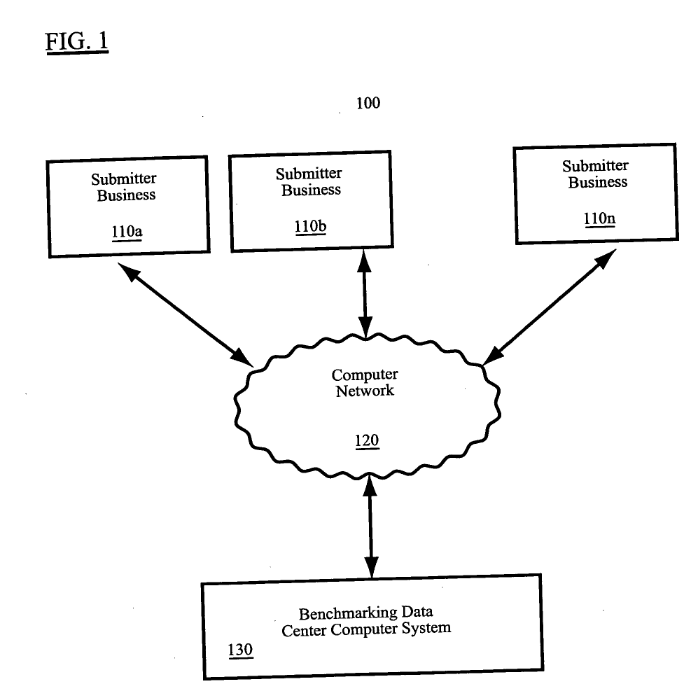

FIGS. 1-17 illustrate exemplary systems and methods for gathering, standardizing, aggregating, analyzing, benchmarking, maintaining and displaying business performance data over a communications network. Business performance data may include, but is not limited to, financial information related to a business including net income, gross sales receipts, total assets, total liabilities, cash, and the like. Business performance data may also include combinations of financial and operational information such as revenue per employee, gross margin per store, etc. In various exemplary embodiments according to this invention, business performance data is maintained by an individual business using one of various COTS accounting software programs. In various embodiments, operational data may be maintained separately or simply keyed in by the user of the system.

In various exemplary embodiments of the systems and methods according to this invention, using COTS accounting software, a business may export performance information in the form of, for example, a trial balance worksheet, which provides debit and credit balances for all balance sheet and income statement accounts, to a file and will submit this information to the business performance information benchmarking system of the present invention. As is known in the art, a trial balance is a worksheet listing all general ledger accounts and their debit or credit balance. Using a conversion mapping process, the business performance information is standardized by converting from the submitter-defined format to a standardized format. In various exemplary embodiments, mapping of the business performance information is performed by a process including a combination of one or more operator processes and one or more automated processes. In various other exemplary embodiments, the mapping of business performance information is performed by a completely automated process performed using one or more software programs. In various exemplary embodiments, conversion will be performed in a manner consistent with that disclosed in related patent application Ser. No. 10/830,115 which has been incorporated by reference.

In various exemplary embodiments of this invention, once converted, the business performance information is aggregated with business performance information of other companies for benchmarking purposes. In various embodiments, this aggregation may be done in conjunction with one or more business classification codes provided by a submitter so that business performance information of like businesses are stored together. However, in various other embodiments, all business performance data will be stored in the same database and will be filtered on the basis of one or more business classification codes at the time of benchmarking. In still further embodiments, submitter business performance data will be aggregated with other businesses performance information based on one or more other fields such as geographic location of the business, number of employees, amount of revenue, etc.

Various analysis techniques may be performed on the converted business performance information in conjunction with and/or in addition to benchmarking, either in aggregation or for a particular business, and one or more performance reports and/or alerts may be generated from the results of the analysis. These analysis techniques and performance report generation features also may be implemented as automated processes using one or more software programs.

In various exemplary embodiments, the system of the present invention will convert the submitter's business performance information along with the results of benchmarking against aggregated business performance information to a graphical data presentation and perform financial analysis on the business performance information in accordance with various known financial analysis techniques, including analyzing the financial information using one or more financial metrics. The term “financial metrics,” as used herein, generally refers to a standard of measurement used in the financial and accounting sector to indicate the profitability, efficiency, stability, vulnerability, etc. of a business. Financial metrics may include snapshot metrics such as cash on hand, current ratio, etc. Financial metrics may include aggregate metrics such as net profits, net sales, etc. Financial metrics may also include derivative metrics such as revenue growth, earnings growth, etc. that require a rate of growth calculation. Unless otherwise noted, the use of the term financial metrics applies to snapshot metrics, aggregate metrics and derivative metrics as well as any other generally accepted categories of metrics.

As discussed herein, in various embodiments, a submitter business' standardized business performance information will be aggregated with business performance information of other businesses. From a portion of all of the aggregated information, one or more performance metrics representative of the average or collective performance of the aggregate businesses may be identified. Business performance information from a particular business then may be compared to the representative performance metric(s) of the aggregated information to benchmark the performance of the particular business relative to similar businesses in order to determine and visualize the relative performance of the submitter business as compared to averages for other similar businesses. In various embodiments, similarity will be determined based on one or more submitter-provided business classification codes. In various other embodiments, similarity will be determined by other user-defined parameters. In still further embodiments, similarity may be determined by the system itself without user input.

In various embodiments, benchmarking will be performed by deriving values for one or more of the financial metrics for the business performance information of the submitter business and values for the same one or more financial metrics for aggregate business performance information of other businesses. In various embodiments, the aggregate business performance information will be comprised of aggregate business performance information that includes business performance information of the company whose information is being benchmarked. In various other embodiments, the aggregate averaged business performance will intentionally exclude the business performance information of the company whose information is being benchmarked. In still further embodiments, the user will be able to selectively include and exclude from the aggregate averaged business performance information the business performance information of the company whose information is being benchmarked.

In various exemplary embodiments, financial metrics and benchmarked data will be presented to users of the business performance information benchmarking system on an interactive benchmarking dashboard viewable with a web browser client. In various embodiments, the interactive benchmarking dashboard will list one or more financial metrics with values for the submitter business as well as aggregate values for businesses in the same industry, or in a user-defined peer group of businesses. In various embodiments, the interactive dashboard will permit the user to graph one or more metrics for the submitter business against the industry and/or segments of the industry. In various embodiments, the interactive dashboard will allow the user to set up one or more variance thresholds corresponding to benchmarking results for one or more financial metrics so that the submitter is notified if his/her business performance data exceeds or fails to exceed the one or more variance thresholds. In various exemplary embodiments, notifying will consist of sending an automated email message, displaying an alert on the interactive benchmarking dashboard, contact the submitter through other means and/or combinations thereof.

In various exemplary embodiments, the interactive benchmarking dashboard will include a peer group control module that allows the user to further define the type of businesses whose performance data is included in the aggregate averaged benchmark data. For example, this may include controls for filtering businesses based on business classification code, geographic location, number of employees, total revenues, financial attribute, and/or other user-specified classifications.

In general, benchmarking capabilities will be available only to businesses who submit their business performance information to the business performance information benchmarking system of this invention for inclusion with the benchmarking database of aggregate business performance information. However, other entities, such as, for example, media companies, forecasters, financial services companies, lending institutions, etc. may, in various embodiments, view benchmarking information on their customers. Also, other entities not contributing business performance information to the system may access the system to view aggregated business performance information so as to determine trends within an industry, for example, trends for one or more financial metrics based on business classification code, size of company, geographic location, etc., without viewing the benchmarking results of a specific company relative to the industry.

It is important to note that in all embodiments of this invention, business performance information data belonging to submitters is maintained in such away that those interacting with the system, either those benchmarking their business performance data against the industry or those simply using the benchmarking system to determine performance of the industry itself, may not, unless authorized by the submitter, correlate business performance information to a particular business or discern the identity of a particular business based on the aggregated business information. That is, business performance data is maintained in anonymity with respect to the name of the business that the performance information belongs to. Therefore, submitter businesses may be assured that other parties will not be able to view their business performance data other than anonymously and in the aggregate with other businesses, generally in like industries, and that their identity cannot be determined from the aggregate data. Moreover, the data is maintained on a secure computer server to which access is protected in accordance with known security and authentication techniques. Furthermore, as an additional precaution, in various embodiments, the minimum number of businesses used in the aggregate data is sufficiently large so as to render it impossible to correlate aggregated business performance information to a particular submitter based on known or suspected attributes of that business. Benchmarking will be unavailable within a particular industry if data for this minimum number of businesses is not included in the aggregate data. This also insures that the benchmarking is meaningful to the extent that the aggregate data is indicative of trends within the industry.

Generally speaking, once a submitter or other entity has submitted business performance information to the system according to various embodiments of this invention, that information becomes part of the aggregated business performance information for benchmarking and therefore may only be accessed by other companies in an aggregate anonymous format as discussed above. However, in various embodiments, it may be possible for the submitter to designate other parties that are able to view its business performance data relative to the industry, such as, for example, as discussed in application Ser. No. 10/893,495. That is, the submitter may designate others who are able to view its business performance dashboard utilizing the same views and interface available to the submitter. However, the default will be for no other business to be able to access a particular submitter's business performance information other than in an anonymous and aggregated format, as included with the business performance information of other businesses in the same industry.

As discussed briefly above, for purposes of example and ease of illustration, the present invention is described herein in the context of acquiring, standardizing, aggregating, analyzing, maintaining, benchmarking and displaying of business performance information provided by private businesses. However, it should be appreciated that the exemplary systems and methods discussed herein may be adapted to benchmarking business performance information for other business entities as well. Indeed, the present invention could be implemented to benchmark business performance information of public corporations, non-profit organizations, government agencies and other entities, to mix data from private companies with that of publicly-traded companies and even to benchmark private company business performance information against only publicly-traded companies of public companies against private, without departing from the spirit or scope of this invention.

For ease of illustration and simplicity, FIGS. 1-17 illustrates embodiments of the invention in terms of a generic and substantially standardized submitter interface. However, it should be appreciated that various embodiments of the invention may incorporate an interface that has been customized to promote brand recognition of a provider of the benchmarking service or even for a specific business, such as, for example, a benchmarking service reseller business. Such a customized interface may include, but should not be limited to, presentation of graphic images incorporating marks associated with the specific business, a data center web address that is customized for the specific business, data mapping and analysis functions that are selected by a specific business, a business information presentation screen that has fields and financial metrics that are customized in accordance with preferences of the specific business, electronic links to other web pages associated with and/or maintained by the specific business, and other specific business customizations and/or branding. In various embodiments of the present invention, several specific businesses may each have their own “brand-specific” front end interface to the business performance information benchmarking system, while the business performance information benchmarking system provides common back-end functionality to each.

Referring now to FIG. 1, FIG. 1 is a schematic diagram illustrating the components of a network-based business performance information benchmarking system according to various exemplary embodiments of this invention. As shown in FIG. 1, the network-based business performance information benchmarking system 100 is comprised of a plurality of submitter business computer systems 110a, 110b, 110c to 110n, where n is an arbitrary integer, a benchmarking data center computer system 130, and a computer network 120. The submitter business computer systems 110a-n and the benchmarking data center computer system 130 interface via a communications network 120, for example, the Internet.

For ease of illustration, FIG. 1 represents each of the submitter businesses 110a-n as a single computer system. However, any number of computer systems which are able to access the benchmarking data center computer system 130 may serve as a submitter computer systems. It is the identification information of the operator logging into the benchmarking data center computer system 130 that renders the computer system a submitter business computer system. In addition, for ease of illustration and explanation, the benchmarking data center computer system 130 is illustrated in FIG. 1 as a single computer system. However, it should be appreciated that the benchmarking data center computer system 130 may be a distributed computer network comprising multiple server computer systems, a grid computer system, a token ring network, a star network, or another suitable localized or distributed computer system. The specific topology of the benchmarking data system computer system 130 is not critical to the invention. Indeed, the benchmarking data center computer system 130 of the present invention will be compatible with various topologies so long as the benchmarking data center computer system 130 may be conveniently accessed over a communications network.

With continued reference to FIG. 1, the computer network 120 serves as the gateway between the submitter businesses 110a-n and the benchmarking data center computer system 130. As will be discussed in greater detail herein, maintaining business performance data centrally and permitting interaction over the Internet permits quick and efficient access to benchmarking functionality provided by the data center computer system 130. Utilizing email messages, the data center computer system 130 may invite potential submitters to participate in the benchmarking services provided by the computer system 130 by including a click-through link in the email messages that routes the potential submitter to registration screen where he/she can register an interest in participating in the benchmarking services. Also, by making benchmarking functionality accessible over the Internet, subscribers do not need a proprietary interface client to utilize benchmarking services. Rather, they only need a network connection and a web-compliant browser client such, for example, the MICROSOFT INTERNET EXPLORER client developed and marketed by MICROSOFT Corporation of Redmond, Wash.

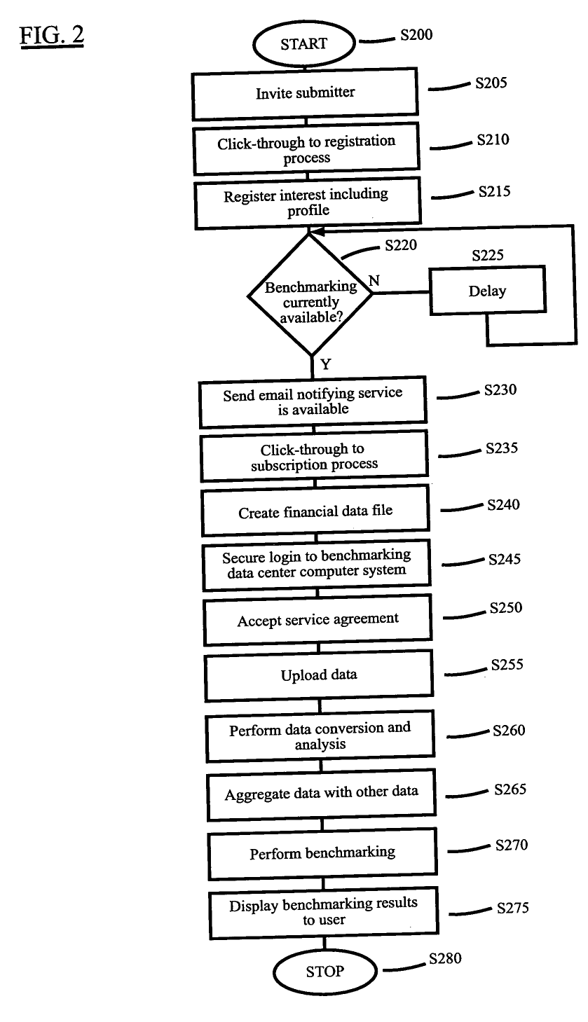

Referring to now to FIG. 2, FIG. 2 is a flow chart illustrating the steps of a method for benchmarking a submitter business' business performance information against aggregated average business performance information according to at least one embodiment of this invention. Operation of the method begins in step S200 and proceeds to step S205, where a potential submitter of business performance information to the benchmarking data center computer system of the present invention is invited, typically through an electronic mail message, to register interest in receiving business performance benchmarking. In various embodiments, the electronic mail message sent out in step S205 will include a click-through link to direct the submitter to a web page where he/she can register his/her company. Step S210 is initiated when the user select the click-through link.

Operation of the method then proceeds to step S215 wherein the user fills out a registration page including a designation of the type of business that his/her company is engaged in. In various embodiments, this will be a SIC and/or NAICS code. Then, in step S215, the user will register his information by selecting a link on the registration webpage. This will cause the benchmarking data center computer system, in step S220, to determine if benchmarking is available for that submitter's particular industry. In various embodiments this is performed by using the industry classification code or codes supplied by the registrant in S215. If, in step S220, it is determined that benchmarking is available, operation of the method proceeds to step S230. Otherwise, operation of the method goes to step S225 where a delay occurs. If, in step S220 it is determined that benchmarking is not currently available, the registrant is notified either on a post registration screen or in a separate electronic mail message that benchmarking is not currently available for his/her industry, but that as soon benchmarking is available for that industry, a notification will be sent to the registrant. The purpose of the delay is to allow other businesses having the same classification code or codes to register an interest in benchmarking. In various embodiments, the delay will extend until a particular number of companies having the same classification code or codes have registered an interest in benchmarking. After expiration of the delay, operation returns to step S220 where the system again checks to determine if benchmarking is available for the registrant's industry.

In step S230, after it is determined that benchmarking is available for the registrant's industry, an electronic mail message is sent to the registrant based on the contact information supplied during the registration process of step S215. The electronic mail message will indicate to the registrant that benchmarking is now available for his/her industry. In various embodiments, the electronic mail message will also include a click-through link to invoke the user's web browser and direct him to a website associated with the benchmarking system. In step S235, the click-through link is selected to invoke the user's web browser and direct him/her to a web page to begin the benchmarking process. The benchmarking process begins in step S240 where the submitter creates a business performance information file. It should be noted that this step may actually be performed prior to or contemporaneous with other preceding steps. It is preferable that the submitter use the most recent business performance data at the time of registering, but this does not necessarily require that the data file be created just prior to uploading. As discussed herein, the data file is typically one that was created in whatever COTS accounting software program that is used to maintain the submitter's books. Most, if not all, COTS accounting software programs have a data export function that allows data from either the general ledger or various sub statements to be exported to a spreadsheet file format or a text file format. In a preferred embodiment, the business performance information will be a trial balance statement. As noted above, an in the accounting field generally, a trial balance statement is a worksheet listing all general ledger accounts and their debit or credit balance. In various other embodiments, the business performance report file may be provided in a raw format or may be arranged in any of a variety of performance reporting formats, such as ledgers, income statements, balance sheets, operation specifications, etc. Preferably, the business performance report file is provided in electronic form and in a file format used by any number of the COTS accounting software programs. A copy of this electronic file will be saved locally. However, in other embodiments, the business performance report file may be provided in hard-copy format (e.g., a print out of the general ledger, income statement, balance sheet and/or cash flow statement), and the information represented on the hard copies may be converted to electronic form for the business performance information benchmarking data center computer system by manual entry or by using an optical character recognition (OCR) scanning process. Alternatively, the data may be provided on a CD, storage device or other physical storage medium that contains aggregate business performance information of one or multiple businesses and be manually uploaded to the system with or without performing standardizing or data conversion prior to the data upload.

It should be noted, that in various exemplary embodiments, the submitter's business performance information will already be on file with either a reseller of the benchmarking services or with a business performance information management service provider associated with the benchmarking service provider due to previous contractual relationships. For example, in the first instance, if the benchmarking service is being offered to its customers by an entity such as a bank or a CPA firm, the bank or CPA firm may have already uploaded the submitter's business performance information to a system associated with the business performance information data center computer system in a manner consistent with that disclosed in application Ser. No. 10/830,115. In such a case, the step of uploading will be excluded because the initial data as well as periodically updated data will already be available to the business performance benchmarking data center computer system. In this example, benchmarking is merely an additional service either purchased by the end user or by the bank or CPA firm on behalf of the end user.

Alternatively, the submitter may have an existing contractual relationship with a business performance information management system such as disclosed in application Ser. No. 10/830,115 or application Ser. No. 10/893,495. In this case too, the user will not need to perform the redundant step of uploading because his/her business performance information will already be available to the benchmarking data center computer system. Benchmarking will simply be another service subscribed to by the end user in addition to data management and sharing services disclosed in these applications.

Whether the submitter's business performance information is already on file with either a reseller of the benchmarking services or with a business performance information management service provider associated with the benchmarking service provider due to previous contractual relationships, the other steps of the method outlined in FIG. 2 will still be relevant. For example, in step S205, the submitter/subscriber may be initially invited to register an interest in benchmarking. Then, in step S210, the user may select a click-through link included in the invitation cause a web browser client on the submitter's computer system to be invoked and directed to a web site associated with the benchmarking system. Next, in step S215, the user will register his interest in benchmarking including specifying at least one business classification code corresponding to the submitter's business. As discussed herein, specifying may comprise keying in, selecting from a drop down menu, or other suitable entry means. In step S220, based on the at least one classification code, the system will determine if benchmarking is available for the submitter's industry. If so, operation proceeds to step S250 where the submitter/subscriber is directed to a web page presenting a copy of the benchmarking service agreement, which must be accepted before proceeding. Otherwise, operation of the method proceeds to step S225 in a manner previously discussed. If the submitter/subscriber accepts the terms in step S250, operation proceeds to step S270 where benchmarking is performed. Subsequent operation then proceeds according to the same steps as if data were being uploaded by the submitter/subscriber.

Returning to operation of the method in the case where the submitter's data is not yet available to the benchmarking data center computer system, operation of the method goes from step 240 to step S245 where the submitter performs a secure log in to the benchmarking data center computer system using credentials established during the registration of step S215. Then, in step S245, the submitter is provided with a copy of the benchmarking service agreement. In a preferred embodiment, the service agreement is displayed directly in a web page being viewed by the submitter. In order to proceed any further, the submitter must acknowledge that he/she has read and agrees with the terms of the benchmarking service agreement. Though not shown in the flow chart of FIG. 2, the submitter, if contracting directly with the benchmarking system provider, will also be presented with a credit card payment screen through which the user will submit credit card information in order to pay for access to the system. Terms of the credit card agreement may be included in the service agreement or in another agreement viewable on the credit card payment screen. Because such online payment screens are ubiquitously well known in the art, a detailed description them has been intentionally omitted. If, in contrast, the submitter is accessing the system through another institution, such as a bank or CPA firm, the bank or CPA firm will typically contract directly with the benchmarking service provider. In such a case, the user may or may not be presented with a billing screen, according to the specific practices of the bank or CPA firm.

Then, assuming that the submitter agrees with the terms, and selects an acceptance button included on the service agreement page, in step S250, the user is taken to a data upload page where he/she is presented with several fields used to describe the name, format and actual location of the business performance data file of step S235. After information has been supplied to these fields describing the name, format and location of the business performance data file, the submitter's business performance data must be uploaded. In a preferred embodiment, this step comprises uploading the business performance information through a web page including an upload link. In an alternative embodiment, this step may comprise sending the file to the data center computer system using a file transfer protocol application (FTP). In yet another alternative embodiment, this step may comprise attaching the business performance information file to an electronic mail message and sending it to an electronic mail address associated with the business performance information benchmarking data center computer system. Alternatively, this may comprise sending a CD or other storage device containing the business performance information to the administrators of the benchmarking system. If, as discussed above, the business performance information file is not in an electronic format, this step will require one of faxing a printout of the business performance information file, mailing a hard copy of the business performance information file or otherwise delivering a physical copy of the business performance information to an agent associated with the business performance information benchmarking data center computer system so that it may be entered to the data center computer system, through either a manual or electronic data entry process. Then, in step S255, the user selects an upload button to initiate the actual upload process. Depending on the speed of the submitter's Internet connection and size of the file, some delay may occur while the file uploads.

Once the business performance data file has been successfully uploaded in step S255, processing proceeds to step S260 where data conversion and analysis are performed by the benchmarking data center computer system. As will be discussed in greater detail herein, in various exemplary embodiments, the data conversion process S260 converts the data from the submitter-defined format into a standardized format including a combination of text and graphics using a conversion mapping process preferably performed using one or more software programs. Furthermore, in various exemplary embodiments, one or more financial data analyses are performed on the data including calculating values for one or more financial metrics based on the business performance data.

With continued reference to the method illustrated in FIG. 2, next, in step S265, the converted business performance data of the submitter business is aggregated with other businesses to contribute to the pool of aggregate data for that industry. Then, in step S270 benchmarking is performed. In various exemplary embodiments, the steps of conversion S260, aggregation S265 and benchmarking S270 will be performed in real time while the submitter waits. However, in various other embodiments, these steps will be performed off line, over a period of time such as, for example, in a batch process occurring only once every N hours, days, etc. In this latter instance, the submitter will exit the benchmarking data center computer system until he/she receives a notification, preferably an electronic mail notification, that the conversion, analysis and benchmarking are completed and including a click-through link to invoke the submitter's web browser and return him/her to the benchmarking data center computer system to continue the process. However, the notification may also comprise a facsimile notification, a telephone notification, a regular mail notification or other suitable notification mechanism.

Next, in step S275, after the submitter has either waited for the results online, or has returned after being notified and re-authenticated, the submitter is presented with a view of the results of the conversion, analysis and benchmarking. In various embodiments, and as will be discussed in greater detail herein, the submitter will be presented with an interactive benchmarking dashboard including a combination of graphics and text indicating the results the conversion, analysis and benchmarking.

Operation of the method ends in step S275. However, it should be noted that in various embodiments of the invention, after the submitter has initially uploaded his data and viewed the results of the benchmarking, analysis and conversation, the user will subsequently access the system in order to periodically upload updated business performance information, such as, for example, each time the submitter's financial books are closed and to continue to view the results of benchmarking. In various exemplary embodiments, at the time of first login to the benchmarking data center computer system, the submitter will specify the frequency with which his/her financial books are closed so that the system can send automatic email reminders to the submitter reminding him/her to upload updated business performance information. Alternatively, the submitter may be reminded to upload quarterly or with some other predetermined or submitter-defined frequency. In such circumstances, the submitter begins the operation in step S255 where new data is uploaded, after going through a secure log in screen associated with the benchmarking data center computer system.

In addition to uploading new business performance data, the submitter may want to simply re-access his/her benchmarking results to perform different benchmarking scenarios for the current or a previous reporting period. In this case, the submitter proceeds directly to step S270 after going through a secure log in procedure.

By gathering business performance information, converting it to a standardized format, analyzing the business performance information, aggregating the business performance information, benchmarking the business performance information and generating one or more performance reports using one or more automated processes, the business performance information benchmarking data center computer system can assist a submitter in analyzing the performance of their business by allowing the submitter to review the results of the benchmarking analysis in a familiar, organized, standardized, meaningful and accurate format, in a fraction of the time required by conventional techniques and in conjunction with aggregated average business performance information of other businesses in the same industry and/or with other submitter-defined attributes. Furthermore, the benchmarking data center computer system allows businesses to compare their business performance to other businesses in the same industry on a periodic basis to determine their relative performance within the industry; a valuable service that has hitherto been unavailable to private companies. Through the benchmarking system defined herein, the submitter may find answers to questions such as “Did I grow faster than my industry group this period?”, “Is my business trending ahead of or behind my competitors?”, “Are my profit margins in line with industry averages?”, “How do my direct and indirect costs compare?”, “Do I have higher financial leverage than companies of similar size?”, “Do I have opportunities to improve A/R or inventory turns based on industry values?”, etc. By taking data directly from the general ledger accounting system of businesses through a trial balance report, the aggregated benchmarking data is accurate and relevant and includes many individual metrics that can be gleaned from the this report. Also, by promoting frequent submitter updates, the aggregated benchmarking data is timely. Still further, because the data is aggregated anonymously, there are no disclosure/security issues that might otherwise dissuade a company from participating in the system. Other useful and novel features of the invention, as will be discussed in greater detail herein, include the ability to customize the peer group of same industry companies based on user-selected parameters, alerts and variances which may be customized to alert the user of benchmarking results, which, for one or more specific metrics exceed or fail to exceed a certain threshold relative to the peer group, and even advanced analytics such as top and bottom quartile benchmarking comparisons.

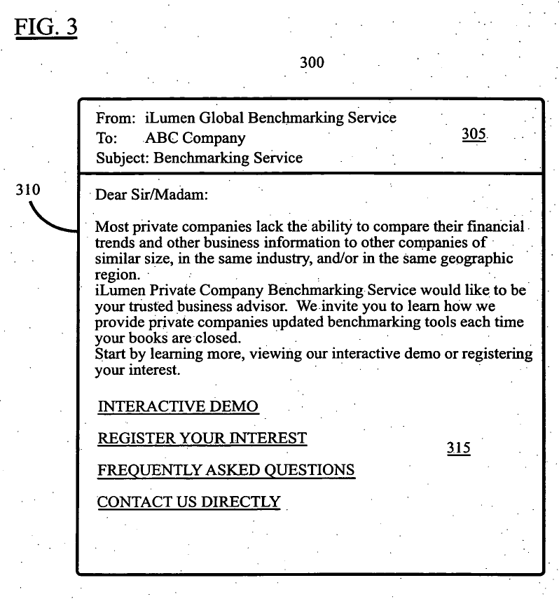

FIGS. 3, 4 and 6-16 illustrate various electronic mail messages, browser window views, and benchmarking dashboard components according to embodiments of this invention. It should be appreciated that the layout of these messages, views and components is exemplary only. The specific design and layout shown in these figures are not critical to the invention. Rather, any number of different formats and layouts operable to support the underlying novel functionality may be utilized without departing from the spirit or scope of this invention. Referring now to FIG. 3, FIG. 3 is a graphic image illustrating an exemplary electronic mail message including an invitation to register interest in participating in a network-based business performance benchmarking system according to at least one embodiment of this invention. The mail message 300 of FIG. 3 includes a customized message 310 informing a company about the benchmarking service and inviting the company to register its interest in benchmarking. In various embodiments, the electronic mail message 300 will include a series of click-through links 315 to various external functions. As shown in FIG. 3, the external links 315 include links to an interactive demo, a link to register the company's interest in private company benchmarking, a link to a frequently asked questions (FAQ's) page and a contact us link, which in various embodiments will invoke the user's email client to send an email message to the representatives of the benchmarking system. The links illustrated in the links section 315 of FIG. 3 should be interpreted as exemplary only. In practical application, fewer, more, or even completely different links may be utilized. In various embodiments, selecting the “Register Your Interest” link will invoke the user's web browser and direct him/her to a registration web page associated with the benchmarking system.

Though the electronic mail message of FIG. 3 is shown in the header section 305 as coming from the company providing the benchmarking service, it should be noted that the message may come from a third party, such as, for example, a bank or CPA firm or other entity who is promoting or reselling the benchmarking services to its clients in order to allow them to better evaluate their business performance by benchmarking themselves against aggregate averaged business performance information of other companies in the same industry. As noted above, because the information is aggregated and is not traceable back to its source, private companies may be more incentivized to participate in the benchmarking service and to contribute their business performance information to the aggregated data.

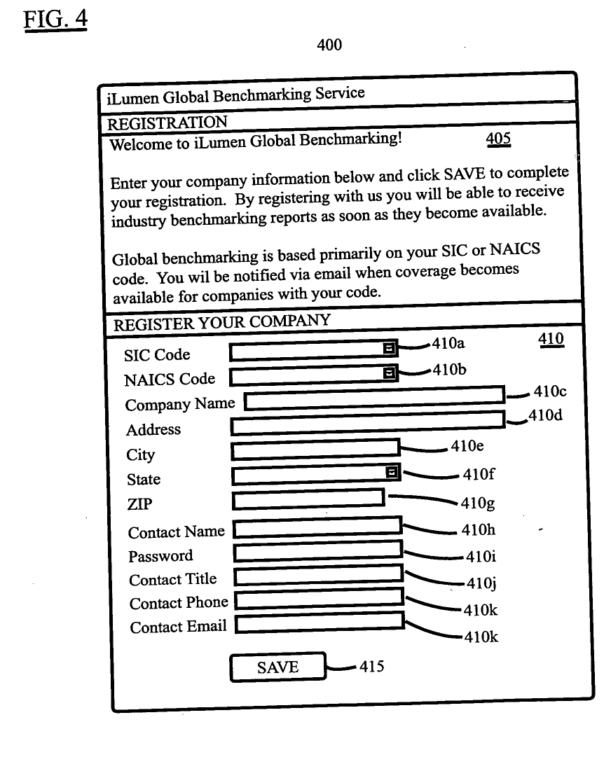

Referring now to FIG. 4, FIG. 4 is a graphic image illustrating an exemplary registration screen of a web browser client for registering interest in subscribing to a network-based business performance information benchmarking system according to at least one embodiment of this invention. As illustrated in FIG. 4, the registration screen 400 includes a welcome message section 405 and a set of form entry fields 410 comprising a detailed company profile. The form entry fields shown in the registration screen 400 include an SIC code pull-down field 410a, an NAICS code pull-down field 410b, a company name field 410c, an address field 410d, a city field 410e, a state field 410f, a zip code field 410g, a password field 410h, a contact name field 410i, a contact title field 410j, a contact phone field 410k and a contact email field 410l. Though not show, the registration screen 400 may also include fields that allow the registrant to specify various other operational data not typically included in a general ledger of other accounting reports, such as, for example, number of employees, number of stores, square footage, etc. The screen 400 of FIG. 4 also contains a save button 415 which, when selected by the user, causes the form field information to be saved. The list of fields shown on the form 400 of FIG. 4 is merely exemplary and is not meant to be exhaustive. It may be desirable to use more or less fields and even to use different fields than those shown in FIG. 4. Also, though not shown in the Figure, the SIC code pull-down field 410a, an NAICS code pull-down field 410b may also include links to a look table, such as an alphabetically indexed table of various industrial categories, i.e., retail, food services, etc. and a corresponding code so that these fields can be automatically populated by selecting the appropriate industry description with corresponding code. As noted above in the context of FIG. 2, selecting the save button 415 will cause the system to confirm whether benchmarking is currently available. If so, the user will be taken to a series of pages designed to permit the user to accept the terms of the service agreement, access the benchmarking system, upload business performance information and utilize the various benchmarking functions. Otherwise, in various embodiments, the user will be presented with a closing screen thanking him/her for registering an interest in benchmarking and further stating that a notification will be sent out when benchmarking becomes available for the user's industry and/or type of business.

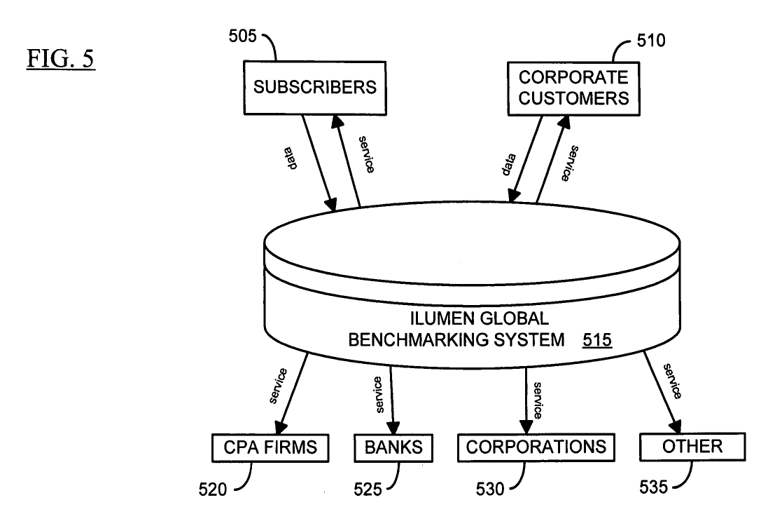

FIG. 5 is a block diagram illustrating the flow of services and data to and from the benchmarking system according to at least one embodiment of this invention. As shown in FIG. 5, in various embodiments, business entities such as private company subscribers 505, which, as discussed herein, may include private companies, partnerships, associations, etc., and corporate customers 510, i.e., firms that are already contracting to upload business performance information for purposes of storing, standardizing, analyzing and sharing the information, as discussed in U.S. patent application Ser. Nos. 10/893,495 and 10/830,115. Both subscribers 505 and corporate customers 510 access and interact with the benchmarking system 515 directly to share business performance information and to receive benchmarking services. Though the categories of subscribers 505 and corporate customers 510 are illustrated in the Figure as single boxes, the boxes merely represent the categories as a whole. It is to be understood that each category of entity 505 and 510 will actually comprises many individual businesses. As additional entities 505 and 510 join the system 515, their business performance information is added to the aggregated business performance information stored on the system 515. In various embodiments, these entities will contract directly with the benchmarking system 515 on a subscription basis to receive benchmarking services. During the period of the subscription they will periodically upload their updated business performance information to the benchmarking system 515 and will be able to access the system 515 on demand to receive benchmarking results. They will also be able to set up automated messaging features from the benchmarking system such as variance alert notifications, upload reminders, and other administrative messages.

In other embodiments, submitter/subscriber contact with the benchmarking system 515 will be conducted through resellers such as CPA firms 520, banks 525, corporations 530 or other entities 535 such as professional/trade associations, VC firms, franchises, etc. These institutions 520, 525, 530, 535 may act as resellers of the benchmarking services or may use the system to analyze business performance of their customers and/or composite businesses vis-à-vis each other, or against aggregate industry data. In the case of CPA firms 520 and banks 525, the resellers may provide benchmarking services to their clients as a stand alone service or as part of a bundle of business performance information management services. In this arrangement business performance information of the Bank's, CPA firm's etc customers/clients who have indicated an interest in receiving benchmarking services is used to “populate” the database at the benchmarking system. Entities 520, 525, 530 and 535 that already maintain business performance information on their customers and/or composite companies, can supply business performance information on many small companies at once, thereby accelerating the time required to obtain a sufficient number of contributors to the aggregated business performance information in each business category.

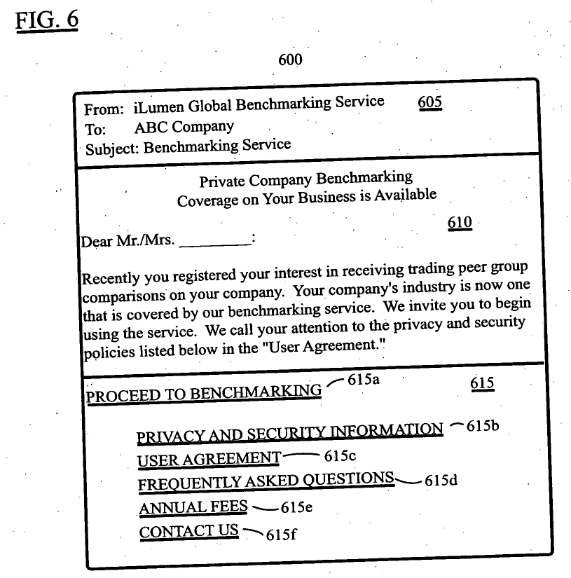

FIG. 6 is a graphic image illustrating an exemplary electronic mail message including an invitation to register interest in participating in a network-based business performance benchmarking system according to at least one embodiment of this invention. The electronic mail message 600 has a notification section 610 that, based on data supplied during registration, includes a personalized message informing the registrant that benchmarking services are now available for his/her business and inviting the registrant to proceed to the benchmarking system to subscribe to the system. The electronic mail message as illustrated in FIG. 6 includes a links section 615 with several click-through links 615a, 615b, 615c, 615d, 615e and 615f. Specifically, the links section 615 includes a link to proceed to benchmarking 615a, a link to the view the privacy and security information 616b relating to the benchmarking system, a link to view the user agreement 615c, an FAQ link 615d, a link to the view the fees 615e and a contact link 615f. As with previous figures, the list of links 615 is not meant to be exhaustive. Fewer, more or even other links may appear in the mail message 600. As discussed herein the context of FIG. 2, in various embodiments of the invention, selecting the proceed to benchmarking link 615a will invoke a web browser client of the registrant's computer system and direct him/her to a web page to initiate the submission process.

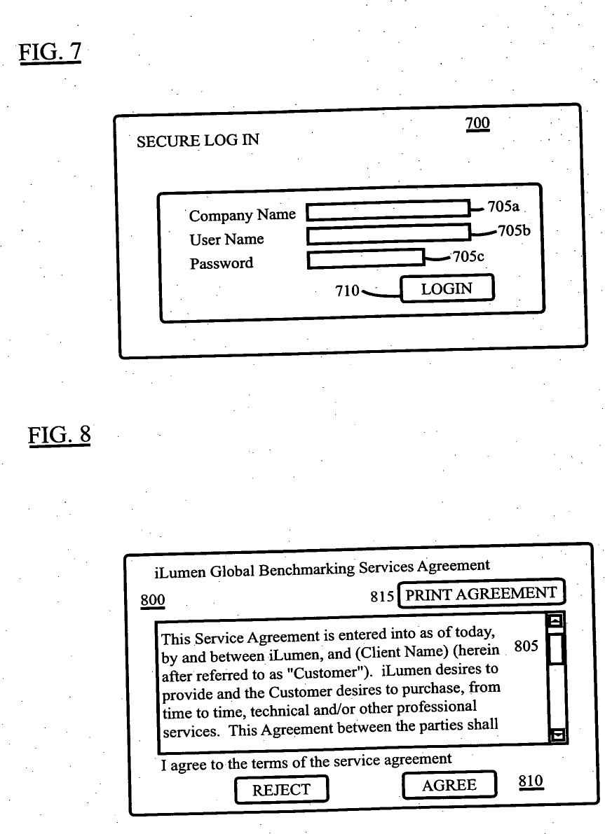

Referring now to FIG. 7, FIG. 7 is a graphic image illustrating an exemplary log-in screen of a web browser client for securely logging in to a business performance information benchmarking system according to at least one embodiment of this invention. In various embodiments, the login screen 700 will be presented to the submitter through his/her Internet browser software application after selecting a “proceed to benchmarking” link on a web page associated with the business performance information benchmarking data center computer system of the present invention. As illustrated in FIG. 7, the secure login screen 700 comprises a Company Name entry field 705a, a User Name entry field 705b and a Password entry field 705c. In various exemplary embodiments, the submitter will have already registered with the business performance information benchmarking system prior to logging in through the secure login screen 700, that is if the user is returning the benchmarking system after having already uploaded his business performance information or if he/she is returning to upload updated business performance information, or if they maintain an account on the system through their bank, CPA firm, etc., in accordance with the inventions disclosed in U.S. patent application Ser. Nos. 10/893,495 and 10/830,115. Thus, if the submitter has previously registered, the login screen 700 merely permits re-authentication of the person logging in. Otherwise, if the submitter has not previously registered, the submitter will be directed to a series of service agreement and data file upload screens that will enable the submitter to participate in the business performance information benchmarking system of the present invention. Also, in various exemplary embodiments, upon registering with the business performance information benchmarking system, a submitter may identify several persons associated with the submitter business who are authorized to interact with the business performance information benchmarking system that is multiple users of the system, such as, for example, employees of the submitter, or employers of other entities approved by the submitter to view benchmarking data for that company. Thus, for a given company name, there may be a plurality of different operator credentials which may be entered to effect login.

Referring now to FIG. 8, a graphic image is shown that illustrates an exemplary service agreement acceptance screen of a web browser client including the body of the agreement and buttons operable to register an acceptance or rejection of the terms of the agreement according to at least one embodiment of this invention. In the screen 800 of FIG. 8 a scrollable window 805 is provided that contains the entire text of the services agreement associated with participation in the benchmarking system of the present invention. Such scrollable agreement windows are typically employed in computer systems which permit online contracting. After reviewing the service agreement, the submitter may select one of either the reject or agree buttons 810a and 810b to register his/her rejection or acceptance of the terms contained therein. In various embodiments, selecting the reject button 810a will terminate the joining process and cause the user to be directed to a closing screen thanking him for his/her interest in private company benchmarking. Otherwise, in various embodiments, selecting the agree button 810b will cause the submitter to be automatically directed to a data upload page in his web browser operable to permit the submitter to upload his business performance information to the benchmarking system. In various embodiments, a print agreement button 815 will also appear on the service agreement acceptance screen 800 operable to invoke a printing device available to the submitter's computer to print a hard copy of the agreement for the submitter's records.

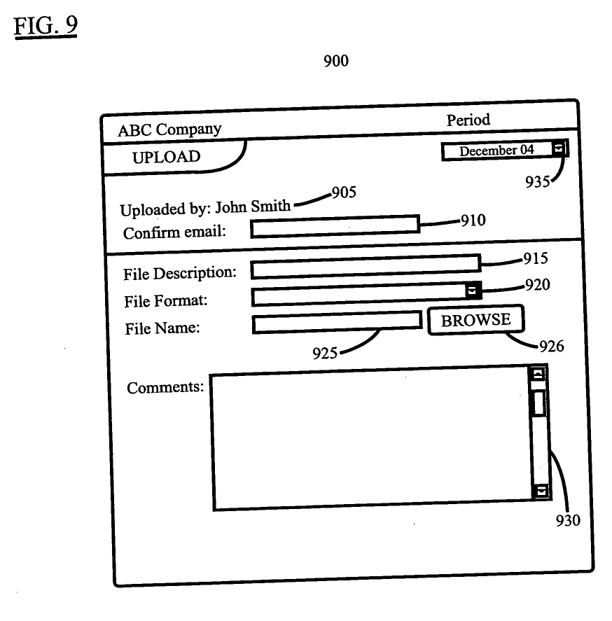

FIG. 9 is a is a graphic image illustrating an exemplary business performance information upload browser window for uploading business performance information to a network-based business performance information benchmarking system according to at least one embodiment of this invention. The exemplary upload window 900 shown in FIG. 9 includes various fields used to characterize the business performance information and includes an interactive button to specify a location of the electronic file containing the submitter's business performance information. As illustrated in FIG. 9, the upload window 900 comprises a plurality of data fields including a submitter name field 905, a confirm email field 910, a file description field 915, a file format field 920, a filed name (path) field 925 with a browse button 926, a comments field 930 and a time period designation field 935. It should be appreciated that the fields shown in FIG. 9 are exemplary only and should not be interpreted as an exhaustive list. In various embodiments, it may be desirable to use more or less fields or even different fields altogether. Moreover, as discussed above, an information upload screen is not the only means of uploading business performance information to the network that is contemplated with this invention. Various other methods including, email attachment, faxing, FTP, regular mail of a storage medium containing the data, manual data entry and combinations thereof may also be utilized.

In various exemplary embodiments, the “uploaded by” field 905 will be pre-populated using credentials supplied by the submitter to the secure login screen. However, in various other embodiments, this field will be user definable. In various exemplary embodiments, and both as a security precaution and to permit the use of different email addresses, the value entered into the “confirm email” field 910 will be compared against previously stored email information for that submitter. In a preferred embodiment, the “file format” field 920 will be a drop down field containing a list of acceptable file formats. The data supplied by the submitter in this field will be used during data conversion and mapping to insure that the correct conversion process is utilized. By selecting the browse button, the submitter may navigate through his available drives to find the correct path and file name of the file containing the business performance information. Such buttons are typically employed in data upload operations to prevent errors due to erroneous entry of the file path and/or name. Finally, the “comments” field 930 will provide an opportunity for the submitter to input any messages or explanations to be viewed with the converted, analyzed and benchmarked performance data. In various exemplary embodiments, the comments input into this field by the submitter will be in the nature of the “Management Discussion and Analysis of Financial Condition and Results of Operations” comments typically included with public company quarterly and annual financial filings. In various embodiments, such as, for example, if a submitter is contracting directly with the benchmarking system, this comment field 930 may not be utilized because to do so may compromise the anonymity of the submitter. Whereas, in other embodiments, particularly when the submitter is a customer of a bank or CPA firm who is already authorized to view business performance information for that company, the comment field 930 may be useful to explain particular anomalies associated with the submitter's business performance information. Therefore, the comment field 930 may or may not appear in versions of the upload screen 900 presented to such users. Once appropriate values have been entered by the submitter for each of the fields of the upload window 900, the submitter selects the upload button 935 to initiate the upload process. In a preferred embodiment, once the upload has been successfully completed, the business performance information benchmarking data center computer system will automatically send a confirmation message to the email address supplied by the submitter on the upload window 900 indicating that upload was a success.

As discussed above in the context of FIG. 2, once the data file has been successfully uploaded, the data conversion, analysis and benchmarking processes occur. In various embodiments, if more than a pre-determined amount of time is required to perform these processes, the submitter will be automatically logged out and taken to a closing screen thanking him/her for submitting his/her company's business performance information to the benchmarking system. A message will be sent at a later time to the submitter once these processes are completed inviting him/her to return to the benchmarking system to view the benchmarking results. Otherwise, the system will ask the user to wait while these operations are performed and will automatically direct the user to the results or provide a link to view the results in his/her browser.

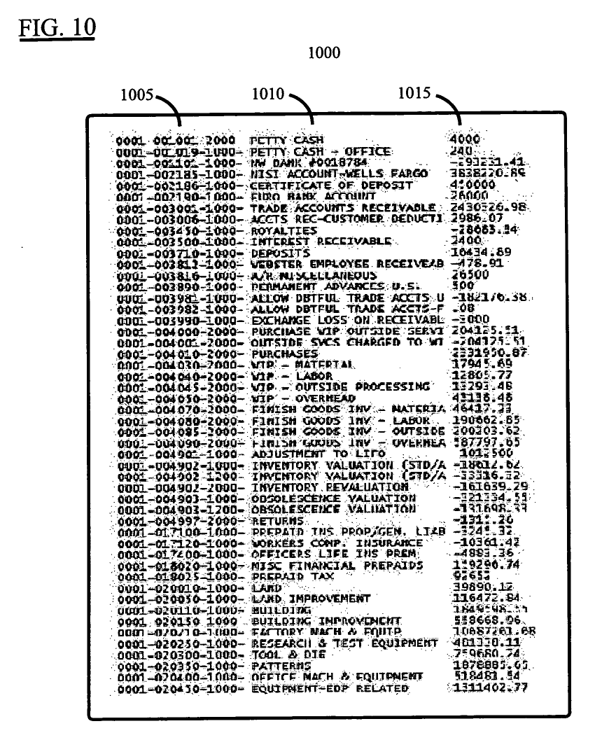

FIG. 10 is a print out of an exemplary trial balance file in a submitter-defined format for upload to a network-based business performance information benchmarking system according to at least one embodiment of this invention. As shown in FIG. 10, the business performance information file 1000 comprises a trial balance formatted as a text file containing three columns of tab delimited text entries of business performance information of a business to be used with the business performance information benchmarking system in accordance with various embodiments of this invention. As discussed above, the business performance information file 1000 may be generated using any one of the available COTS accounting programs and may include data from any table, ledger, balance sheet or other financial form available in the accounting software program. Also, although the trial balance shown in FIG. 10 is formatted as a tab delimited text file 1000, alternatively, a character delimited text file, a spread sheet file, a word processing document file, a proprietary accounting software program file or other file format may be used without departing from the spirit or scope of this invention. Moreover, it may be advantageous to substitute another financial worksheet for the trial balance depending on the submitter's desired level of financial disclosure.

With continued reference to FIG. 10, each data entry in the trial balance text file 1000 consists of an account number field 1005, an account name field 1010 and an account balance field 1015. It should be noted that although the business performance information file 1000 shown in FIG. 10 shows only three fields, it may be desirable to include more or less fields for each entry. In fact, the use of three fields in FIG. 10 is for exemplary purposes only. The present invention is compatible with both more or less fields per table entry. As shown in FIG. 10, the account number field 1005 may include two or more portions, a first portion identifying a unique number associated with that entry and the second identifying whether the entry describes an asset account or a liability account.

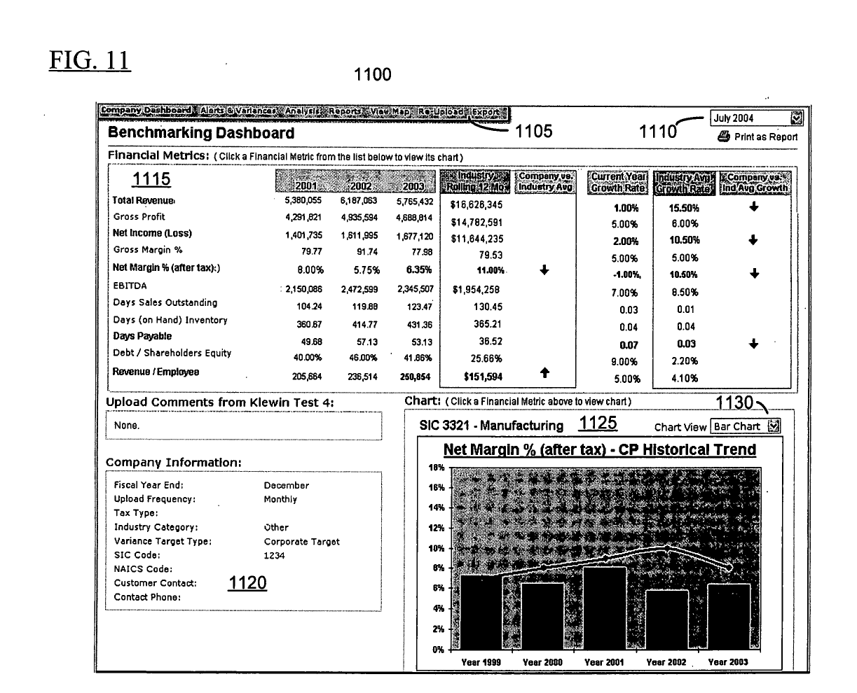

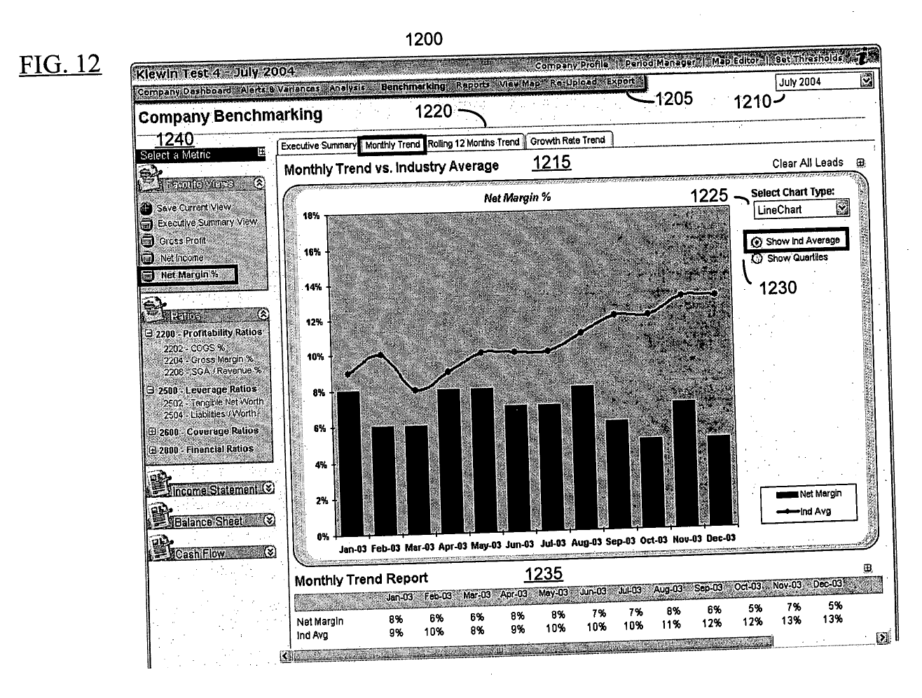

FIG. 11 is a graphic image illustrating an exemplary interactive benchmarking dashboard presenting business performance data of a submitter business in conjunction with aggregate averaged business performance data of other businesses in a combined text and graphic format generated by a network-based business performance information benchmarking system according to at least one embodiment of this invention. In various exemplary embodiments, the benchmarking dashboard is one standardized format created by the conversion and analysis process of the business performance information benchmarking data center computer system according to this invention. However, it should be appreciated that the specific layout of the benchmarking dashboard 1100 shown in FIG. 11 is an exemplary data presentation only.

In various exemplary embodiments, the dashboard 1100 may be automatically loaded after the submitter has successfully logged in, or, alternatively, may be selected from a submitter specific home page having a plurality of different links including links such as “update submitter information,” “upload new performance information,” “view benchmarking dashboard,” etc. As discussed above, if the submitter is not directed to the benchmarking dashboard immediately after uploading his/her data, once the submitter receives a confirmation message indicating that conversion, analysis and benchmarking of the business performance data have been completed, the submitter may then log back into the data center computer system to view the analyzed, reformatted, benchmarked and summarized data as the benchmarking dashboard 1100 shown in FIG. 11. The user will continue to be able to access the dashboard 1100 for as long as their subscription has been paid for, and preferably will return to the system periodically to upload updated business performance data.

The benchmarking dashboard 1100 provides a summarized control point for viewing various aspects of the submitter's business performance data. For example, a top level menu 1105 may be used to access various features provided through the benchmarking dashboard 1100. Also, a time period control menu 1110 may be used to switch the period for which benchmarked data is displayed on the dashboard 1100. A financial metrics section 1115 may be included in the dashboard 1100 that lists various financial metrics including total revenue, gross profit, net income, gross margin percentage, net margin percentage (after tax), EBITDA, etc. Specific choice of financial metrics is not critical to the invention. Rather, any suitable financial metrics may be utilized. In various embodiments, there may be a core set of financial metrics, which can be modified and/or supplemented by the user from a group of available metrics. Additionally, all financial metrics need not appear on the dashboard. Rather, in the alternative, a link may be provided that allows the viewer to access a list of all financial metrics. Alternatively, financial metrics may be accessed through categories of typical financial reports such as balance sheet, income statement, etc., or even in a user definable format that allows the user to define specifically which metrics appear in a given view.

With continued reference to FIG. 1100, for each financial metric 1115, data is provided in tabular format which includes values for that metric for various time periods for the particular submitter business and aggregate, and often averaged, values for the entire industry or a segment of the industry that the submitter operates in. For example, for each financial metric 1115, a value is provided for successive prior reporting years, so that each reporting year may be compared to the other, the industry rolling 12 month average, the submitter company versus the industry average, the current year's growth rate, the industry average growth rate and the trend of the company versus industry average growth rate. In various exemplary embodiments, it may be desirable to include more or less periods for each financial metric 1115 included in the benchmarking dashboard 1100.

Another portion of the benchmarking dashboard 1100 displays the submitter's business information 1120 including any company comments entered and uploaded by the submitter with the business performance data file as shown in FIG. 9. In various exemplary embodiments, the company information will include various identification and classification information for the submitter business including the fiscal year end for that business, the frequency of upload, the corporate structure of the submitter, submitter contact information and type (sector) of business that the submitter business is engaged in, as designated by SIC code, NAICS code or both.

Also included in the benchmarking dashboard view 1100 shown in FIG. 11 is a chart section 1125. As shown in the Figure, the chart is based on data taken from the net margin metric. However, in a preferred embodiment, by selecting any one of the metrics from the list of metrics 1115, the chart will be updated to provide a graphical representation of the data for that metric as indicated on the benchmarking dashboard 1100.

As previously stated, the customized benchmarking dashboard 1100 serves as the primary interface for the submitter to his/her benchmarked business performance information after information has been converted and analyzed by the data center computer system of the present invention. In various exemplary embodiments, by selecting a period pull down menu 1110, the submitter can change the current period to a different period causing information fields in the benchmarking dashboard 1100 to be automatically repopulated with data from the selected period. Also, the top level user menu 1105 may be accessed from the dashboard 1100, permitting the submitter to view various levels of data, see the results of financial analysis, upload additional information, etc. In various exemplary embodiments, the submitter will also be able to update his/her user profile, including adding additional persons authorized to log on and view his benchmarked business performance information from the benchmarking dashboard 1100, updating payment information, and uploading updated business performance data. In various other exemplary embodiments, profile updating is authorized through another process not accessed through the benchmarking dashboard 1100. This other process may comprise a web form, an email message, facsimile, telephone conversation or other suitable authorization mechanism.

FIG. 12 is a graphic image illustrating another exemplary view of an interactive benchmarking dashboard including a graph portion plotting values for a particular metric against an industry average for a user designated time period according to at least one embodiment of this invention. As illustrated in FIG. 12, the graph portion 1200, as with the benchmarking dashboard of FIG. 11, includes a top level menu 1205 for selecting various core dashboard functions. The graph portion 1200 also includes a time period control 1210 for setting a reporting time from which business performance data is chosen for benchmarking. The graph itself 1215 includes a series of view tabs 1215 operable to display graph data in different views, such as, for example, as illustrated in FIG. 12, an executive summary view, a monthly trend view, a rolling 12 months trend view and a growth rate trend view. In the exemplary view of FIG. 12, the monthly trend view is being displayed. Also, the graph itself 1215 includes a chart type selector 1225 for selecting the type chart from a list of available chart types such as, for example a bar chart, a line chart, a histogram, 3-d charts, or other available chart type. As illustrated, the graph 1215 also includes a pair of radio buttons 1230 for selectively adding the industry average and quartile data to the graph 1215. In the exemplary view of FIG. 12, the “show industry average” radio button is selected and can be seen as a line graph on the graph 1215. Under the graph 1215 is a data portion 1235 that lists data entries for the submitter business that serve as the numeric source for submitter's data that is shown in the graph portion. The select a metric portion 1240 allows the viewer to switch between metrics and to expand or collapse various financial statements and ratios so that individual constituent metrics therein can be selected for graphing. In the exemplary view of FIG. 12, the net margin percent (%) is being graphed. In various embodiments, simply clicking on any of the constituent metrics will cause a graph of the metric to appear in the graph itself 1215 and underlying values to be listed in the data portion 1235.

FIG. 13 is a graphic image illustrating another exemplary view of an interactive benchmarking dashboard including a graph portion plotting values for a particular metric against an industry average as well as top and bottom quartiles for a user designated time period according to at least one embodiment of this invention. The image 1300 shown in FIG. 13 is similar to that shown in FIG. 12, except that in the example of FIG. 13, the “show quartiles” radio button is selected from the radio button control portion 1330 causing data for the submitter business, the industry average, the top quartile and the bottom quartile to be simultaneously displayed on the graph itself 1315. The underlying represented data in the graph 1315 is also displayed in the data portion 1335 for all 4 data sources, that is, the submitter business, the industry average, the top quartile and the bottom quartile for the entire analysis period, which in this example, is selected as calendar year 2003. As with the view shown in FIG. 12, the user may select any of the metrics from the select a metric section 1340 to cause it to be graphed in the graph itself 1315 and reflected in the data portion 1335.

FIG. 14 is a graphic image illustrating another exemplary view of an interactive benchmarking dashboard including a peer group control module for specifying one or more adjustable parameters relating to the peer group that is used for benchmarking according to at least one embodiment of this invention. The peer group control module 1400 illustrated in FIG. 14 allows the user, generally the submitter, to selectively filter the companies whose business performance information is contributed to the aggregated average data for benchmarking purposes so that the user can obtain a more meaningful comparison of his business's performance relative to similarly situated businesses. In various embodiments, the peer group control module will be accessible from the benchmarking dashboard. Generally, benchmarking is performed based on one or more business classification codes provided by the submitter. That is, the submitter's business performance information is benchmarked against aggregated data for other businesses having the same business classification code. In various embodiments, the submitter's data may be included in the aggregate data, and in various other embodiments, the submitter's data may be excluded from the aggregate data. Depending upon the particular metric being benchmarked, it may be desirable to include or exclude the submitter's data from the aggregate.

With continued reference to FIG. 14, the peer group control module includes a set of user controlled filters 1405, such as, for example, a geographic area filter 1405a, an entity profile filter 1405b, a size filter 1405c, a financial attributes filter 1405d or other available filter. The filter's 1405 shown in FIG. 14 are exemplary only and are not intended to limit the disclosure to particular filter t types. Within each user controlled filter 1405a-d, there are one or more pull down form fields for selecting a value associated with the particular filter. For example, in the geographic area filter, there is a pull-down form field for region and another pull down form field for state/province. Therefore, the user may restrict the industry data to companies that are in the same geographic region and even within the same state. Given the effect of local and/or regional economies on business performance of companies located therein, more meaningful benchmarking analysis can be provided by limiting the aggregate business performance data to companies that are operating within the same economy. Similarly, more meaningful results can be achieved by limiting the aggregate averaged data to companies of the same size, revenues, etc. Through the peer group control module, users can obtain highly relevant and accurate benchmarking data from a group of peers that are truly comparable to the user's business.

The peer group control module 1400 also has an expandable peer group metrics control 1415 that when selected lists various metrics that can be included or excluded from the peer group filters 1405. A series of buttons 1410a-c are provided for canceling entries and saving entries. Once the user has selected the desired filter settings in the control module 1400, the changes are recorded by selecting the save button 1410b.

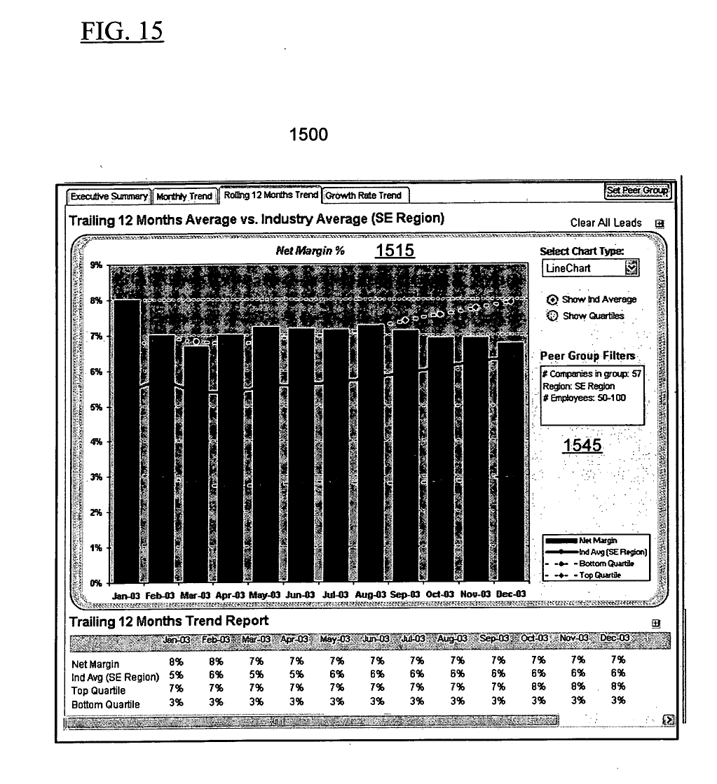

FIG. 15 is a graphic image illustrating another exemplary view of an interactive benchmarking dashboard including a graph portion plotting values for a particular metric against an industry average wherein the members contributing to the industry average have been filtered according to a peer group control module according to at least one embodiment of this invention. The graph portion 1500 is substantially the same as the graph portions shown in FIGS. 12 and 13, except for the use of peer group filtering. As illustrated in FIG. 15, the graph portion 1500 has been rendered using peer group filters. Specifically, the peer group filter section 1545 indicates that the aggregated industry data has been limited to data from peer companies only in the south east region and having between 50 and 100 employees. This has restricted the aggregate averaged data to data from 57 companies. Therefore, the user is able to obtain a more meaningful picture of his/her business's performance relative to peer companies.

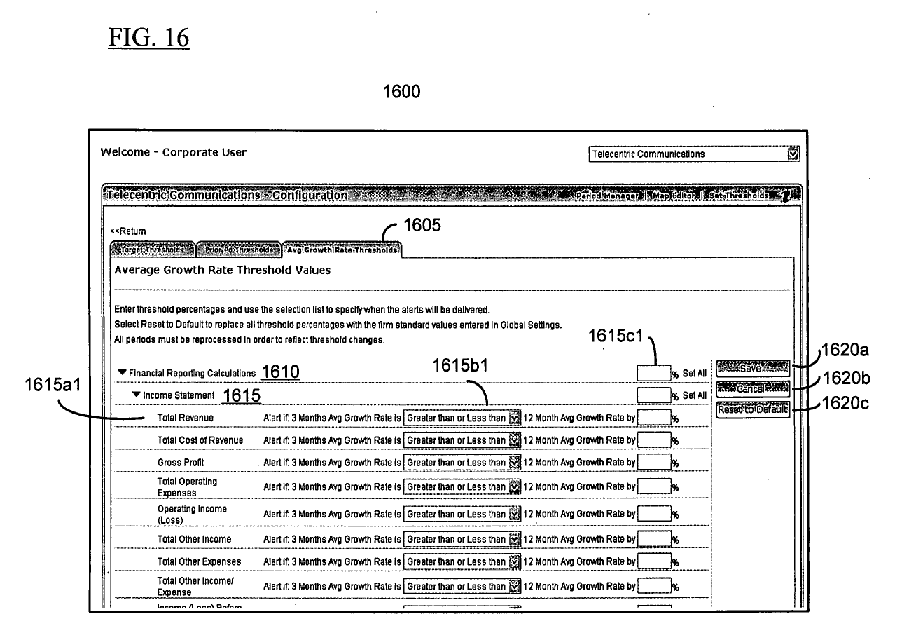

FIG. 16 is a graphic image illustrating an exemplary view of an interactive benchmarking dashboard including a variance and alert module for setting various user-defined variance tolerances of the benchmarking results according to at least one embodiment of this invention. In various embodiments, the variance and alert module 1600 is accessed from the benchmarking dashboard. The variance and alert module 1600 allows users to set various user-defined alerts to be triggered automatically if the results of benchmarking for one or more metrics exceeds or fails to exceed a given threshold. As illustrated in FIG. 16, the variance and alert module has a high level tab menu 1605 that allows the user to select between various categories of thresholds, such as, for example, target thresholds, prior period thresholds, that is changes in the current period relative to the prior period, and average growth rate thresholds. The list of thresholds is not exhaustive, but rather illustrative only. Within in each category of threshold, user's may define variance thresholds for one or more financial metrics. In the example depicted in FIG. 16, the average growth rate threshold category is selected.

In various embodiments, the alerts and variance module 1600 includes a series of drill down categories 1610 that, when expanded, list a series of drill down business performance reports, such as, for example, standard financial reports including income statement, balance sheet, etc. The performance reports themselves can also be drilled down to list each of the constituent metrics that appear in the respective report. As shown in FIG. 16, the income statement report 1615 has been selected. Under the income statement heading appears various business performance metrics 1615a1-aN appearing in the income statement including, for example, total revenue, total cost of revenue, gross profit, total operating expenses, operating income, total other income, total other expenses, etc. Due to limitations on page and screen size, only some financial metrics appear in FIG. 16. In practical application the user would be able to scroll down to reveal other business performance reports and additional metrics.

For each metric 1615a1-aN listed under the income statement report 1610, there is a pull down alert control 1615b1-bN and a user-defined percentage control 1615c1-cN. By using the alert control 1615b1 and the percentage control 1615c1 the user can define an infinite number of different combinations of variance thresholds. For example, for the metric “total revenue,” the user can define a variance threshold wherein an alert is generated if 3 months average growth rate is greater than or less than the 12 month industry average growth rate by 10 percent. Though this alert is an over-under type of alert, other alerts within the scope of this invention may be over only or under only. The benchmarking data center computer system will periodically interrogate the submitter's performance data to determine if the variance threshold has been exceeded. In various embodiments, the data center computer system will interrogate the submitter's performance data each time the submitter uploads new business performance information. In various other embodiments the data center computer system will interrogate the submitter's data more or less frequently, such as every time that new data is added to the aggregate averaged data in the same business classification code or codes as the submitter. Initial threshold values may be set to 0, that is no thresholds are set, or the system may set thresholds for predetermined metrics to predetermined values.

In various embodiments, whenever a variance threshold is exceeded or not exceeded, depending whether it is an over threshold, an under threshold or an over/under threshold, an alert is generated. An alert may take the form of a visual cue on the benchmarking dashboard, such as an icon, a colored arrow, a flashing graphic, a pop-up alert, or other suitable visual alert. Alternatively, an alert may be automatically generated in the form of an email message to the submitter describing the nature of the alert. The email may include texts and graphics sufficient to convey the performance trend that generated the alert. In various embodiments, the email alert may also include a click-through link to invoke the submitter's web browser and return him/her to the benchmarking data center computer system to view his/her latest benchmarking results. In still further embodiments, the alert may consist of both a visual alert on the benchmarking dashboard and an email alert to the submitter so that when the submitter returns to the benchmarking dashboard he is able to quickly determine the particular metric whose performance exceeded the variance threshold causing the alert.

The variance and alert module 1600 also includes a series of buttons 1620a-c for saving, canceling and resetting to default the values entered into the variance and alert module. In various exemplary embodiments, selecting the save button 1620a will cause the user to be automatically returned to the benchmarking dashboard. Default values may be user-defined values may be predetermined by the system, such as greater or less than 15%, or may be 0, that is no variance thresholds will be defined by default.

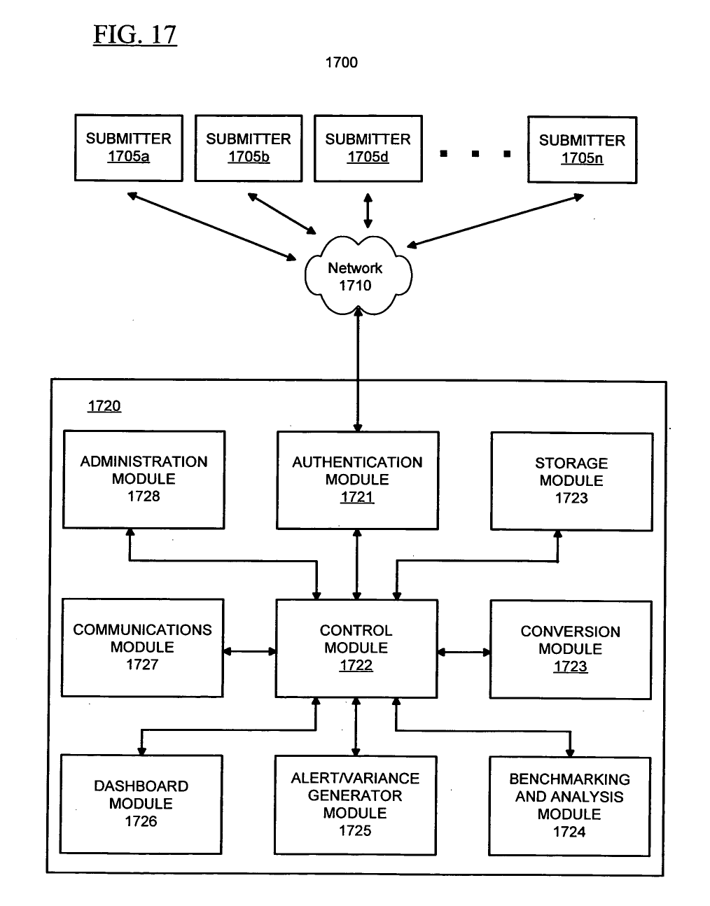

FIG. 17 is block diagram illustrating the internal components of a network-based business performance information benchmarking system according to various exemplary embodiments of this invention. The business performance information benchmarking system 1700 of FIG. 17 includes a plurality of submitter computer systems 1705a-n, operably connected to a benchmarking data center computer system 1720 via a communication network 1710. In various exemplary embodiments, and as illustrated in FIG. 17, the data center computer system 1720 will comprise several task specific modules. Each module may consist of a circuit, route or application, or a subroutine of an overall software program, or multiple software programs in communication with one another. The modules shown in the FIG. 17 include an authentication module 1721, a control module 1722, a storage module 1723, a conversation module 1724, a benchmarking and analysis module 1725, an alerts and variances module 1726, a dashboard module 1727, a communications module 1728 and an administration module 1729. However, it should be appreciated that the modules should not be taken to imply a required structure, but rather as an exemplary embodiment to facilitate system functionality. In various exemplary embodiments, the control module 1722 will be implemented as a microprocessor. However, the control module 1722 may also be implemented as single purpose computer system, a multipurpose computer system, an application specific integrated circuit (ASIC), a microcontroller, or other type control circuit. Moreover, the storage module 1723 may be implemented as a computer hard disk, electronic memory, a combination of electronic memory and a computer hard disk, optical storage, relational database on a storage device, or other suitable storage medium. In various exemplary embodiments, the administration module 1729 will not directly provide functionality to submitters, but rather will be used by administrators of the business performance information benchmarking data center computer system to troubleshoot the system, to upgrade software components, to perform data backup operations, and to perform other administrative operations associated with maintaining the data center computer system 1720.

Though the data center computer system 1720 of FIG. 17 is illustrated as a single contained system it should be appreciated that it may be a distributed computer network comprising multiple server computer systems, a grid computer system, a token ring network, a star network, or another suitable localized or distributed computer system. The specific topology of the benchmarking data system computer system 1720 is not critical to the invention. Also, one or more internal modules 1721-1728 may be located at various distributed physical locations so long as they are able to communicate with the control module 1722 or one or more of the various other modules.

In various embodiments, prior to accessing the benchmarking data center computer system 1720, operations will be primarily occur at the initiation of various modules of the data center computer system 1720. For example, through the administration module 1728, an administrator of the data center computer system 1720 may request that invitations to join the benchmarking system may be sent out by electronic mail to a list of potential submitters/subscribers. As discussed herein, this could be list of customers or a bank or CPA firm who already submit their financial information to the bank or CPA firm, a commercially purchased list of private company CFO's, another list of prospective clients to the system, a list of members of a trade/professional association, a list of franchisees, a list of VC companies, etc. Under the operation of the control module 1722, the communications module 1727 will send an electronic mail message over the network 1710 to the various potential submitter/subscribers 1705a-n based on the electronic mail address included in the list advertising the private company benchmarking service and inviting the recipients to register their interest in private company benchmarking. As discussed herein, in various embodiments, the email message will include a click-through link that will direct a web browser of the receipt to the data center computer system 1720.

Discussion of the business performance information benchmarking data center computer system 1720 will now proceed in the context of submitter functions. Selecting the click-through link will cause the authentication module 1721, under the control of the control module 1722, to display a registration web page loaded from the storage module 1723. Upon the submitter filling in the fields of the registration web page in a manner consistent with that illustrated and discussed in the context of FIG. 4, and selecting a link to save this information included on the page, the information provided by the registrant will be stored in the storage module 1723. The control module 1722 will interrogate the storage module 1723 to determine if benchmarking is currently available for the current registrant's industry. In various embodiments, the storage module 1723 will maintain a file indexed by business classification code with one or more fields for each code, indicative of either the number of companies that have registered interest in benchmarking in that industry, a one bit value indicative, such as 0 or 1, 0 meaning benchmarking is currently available and 1 meaning it is not available, a numeric value indicating the number of business in that industry whose data is included in the aggregate database and combinations of the above. If the control module 1722 determines that benchmarking is available, other modules will be invoked as will be discussed further herein. Otherwise, the control module 1722 will cause a page to be displayed to the submitter thanking him/her for his interest and stating that he/she will be notified when benchmarking becomes available for that submitter's industry.

Periodically, such as, for example, after each time a new submitter registers interest in benchmarking, the control module 1722 will interrogate the file in the storage module 1723 to determine if benchmarking is available. Once the control module 1722 determines that benchmarking is available for a current industry, the communications module 1727, under the control of the control module 1722, will send an email message to each company in that industry that has registered an interest in benchmarking based on the registrant information stored in the storage module 1723. As discussed herein, the email message will preferably include a click-through link operable to invoke the recipient's web browser and direct him to the data center computer system 1720.

When the recipient arrives at the data center computer system 1720, he/she must authenticate through the through the authentication module 1721 using authentication information supplied during registration. In various exemplary embodiments, the authentication module 1721 will authenticate identification information entered through a secure web page. The authentication module will display benchmarking subscriber registration screen from the storage module 1723 containing several fields operable to identify the registrant and his/her company as discussed herein in the context of FIG. 7. The authentication module 1721, under the control of the control module 1722, will compare the entered information against previously registered information for that submitter to prevent unauthorized access to business performance information.

Once a submitter has been authenticated, the control module 1722 will cause an appropriate services agreement page from the storage module 1723 to be displayed to the user. In various embodiments, the control module 1722 will select a services agreement based on the how the submitter is interacting with the system 1720. Operation of the various modules of the system 1720 varies with respect to remaining functions depending upon whether the submitter is coming to the data center computer system 1720 directly or through another party, i.e., a bank or CPA firm. In the former case, after receiving and storing the submitter's acceptance of the services agreement in the storage module 1723, the controller 1722 will display a payment page from the storage module 1723 with fields for entering the submitter's credit card information and an upload button. Entering credit card information and selecting the upload button will cause the control module 1722 to invoke the communications module 1727 to send a message to a credit card validation service to consummate the service purchase. Assuming that the communications module 1727 receives a confirmation of the charge, the control module 1722 displays a page from the storage module 1723 including instructions to prompt the user to upload his business performance information to the data center computer system 1720. In various exemplary embodiments, this process will comprise sending a web page from the storage module 1723 to a submitter computer system 1705 via the communications network 1710 containing a link to upload a business performance information file.

Returning to the latter case, where the submitter is accessing the data center computer system 1720 through another party, i.e., a bank or CPA firm, in this case, the user's business performance information may already reside with the benchmarking data center computer system 1720, or with another data center computer system associated with or accessible by the benchmarking data center computer system 1720, as in systems described in application Ser. Nos. 10/893,495 and 10/830,115 which have been incorporated by reference into this application. In this case, because the data is already available to the computer system 1720, the submitter only needs to affirmatively agree to receive benchmarking services and consent to having its business performance information contributed to the aggregate database. Thus, when the user selects the click-through link in the registration email message, and is authenticated by the authentication module 1721, after interrogating the submitter's record in the storage module 1723, the control module 1722 will determine, based on the submitter's log in credentials, that his information is already stored or available. The control module 1722 will still present a service agreement acceptance page to the submitter/subscriber from the storage module 1723. Consenting to the service agreement will cause the control module 1722 to invoke the analysis and benchmarking module 1724 to begin benchmarking the submitter's business performance information. Because the submitter's information is already stored in the system or available, it is not necessary for the control module 1722 to present a data upload screen to the submitter. However, in various embodiments, it may be desirable to prompt upload of current period data if the most recently uploaded data for the user is outdated. The submitter will be notified once benchmarking results are available by the communications module 1727 in a manner consistent with the situation where the submitter actually uploads his/her business performance information to the data center computer system 1720 as discussed below.

Once the uploaded file has been received, several functions are performed under the instruction of the control module 1722. Firstly, in various exemplary embodiments, the control module 1722 causes the uploaded business performance data file to be stored in the storage module 1723. In various exemplary embodiments, the control module 1722 will also cause the communications module 1728 to send a message to the submitter notifying him that data was successfully uploaded. Then, the control module 1722 will invoke the conversion module 1724 and the benchmarking and analysis module 1725. The conversion module 1724 will reformat the stored business performance data from the user-defined format to a standardized format as discussed herein.

The benchmarking and analysis module 1725 will perform various data analysis operations on the stored business performance data including evaluating the data in accordance with generally accepted business performance metrics. As noted above, the business performance information may have a user-defined format particular to the preferences of the business supplying the information, whereas the performance analysis techniques applied to the business performance information may be ineffective or inaccurate unless the business performance information to be analyzed is compiled in a standard format. Accordingly, the business performance information file may be provided to the conversion module 1724 for conversion to a standard format.

In at least one embodiment, the conversion module 1724 utilizes a conversion mapping process associated with the business to convert the format of the business performance information to a standard format based on the information entered by the submitter describing the format of the business performance information file. In various embodiments, this conversion may be performed in accordance with methods and techniques disclosed in application Ser. Nos. 10/893,495 and 10/830,115. This conversion mapping process preferably implements a map or other data structure which represents a correlation between a submitter-defined business performance classification (e.g., a submitter-defined business performance account or operation classification) of the business performance information in its original format and a corresponding business performance classification (e.g., standard business performance account or operation classification) of the standard format. Thus, when converting the business performance information from the submitter-defined format to the standard format, the conversion module 1724 may use the conversion map to associate the values of the submitter-defined business performance classifications with the corresponding standard business performance classifications. In various exemplary embodiments, this mapping is done in accordance with information provided by the submitter. However, in various other exemplary embodiments, particularly when the submitter is accessing the benchmarking system through another entity such as a bank or CPA firm, where the bank or CPA firm is interested in viewing the submitter's business performance information, the mapping may be done in accordance with information provided by the other entity.

In at least one embodiment, the benchmarking and analysis module 1725 is used to analyze business performance information from a variety of submitter businesses and therefore receives business performance information in a variety of particular formats. Accordingly, the conversion module 1724 may have access to a map database used to store conversion maps for a number of businesses. To map the business performance information for a particular business, the conversion module 1724 may obtain the conversion map associated with the business from the map database and use the conversion map to convert the business performance information.

The conversion map associated with the business may be implemented in a variety of forms. For example, the conversion map may be implemented in a data file as a table or other pairing of an identifier of a user-defined performance classification with the identifier of the corresponding standard performance classification which is stored either in the storage module 1723 or in the conversion module 1724 directly. As an example, the business may have assigned account number 110-01 to the “truck depreciation” account and account number 110-02 to the “other assets depreciation” account, whereas the “asset depreciation” account of the standard format is assigned an account number of, for example, 125.05. Therefore, the conversion map in this example may include a pair listing of (110-01, 125.05) and (110-02, 125.05), thus indicating to the conversion module 1558 that the values associated with the user-defined accounts identified by account numbers 110-01 and 110-02 should be associated with the standard account identified by account number 125.5. Alternately, links between user-defined business performance classification identifiers and standard business performance classification identifiers may be used to create executable software programmed to specifically convert performance information from the particular format to the standard format, where the executable software represents the conversion map. To illustrate, the conversion map associated with a business may be implemented as, for example, a software plug-in executed by the conversion module 1724. Accordingly, the conversion module 1724 may select and execute the appropriate software plug-in to convert business performance information having a submitter-defined format associated with the software plug-in to the standard format.

After conversion by the conversion module 1724, the control module 1722 causes the converted business performance information to be stored in the storage module 1723. Then, the control module 1722 invokes the benchmarking and analysis module 1725 to analyze the converted business performance data. The benchmarking and analysis module 1725 may be adapted to perform any of a variety of performance analysis techniques, including, for example, identification, evaluation and computation of performance metrics, trend analysis of performance metrics, benchmarking of performance metrics based on comparisons to peer businesses, and the like. The analysis module 1560 further may include one or more portfolio-based scenario analyses run on the aggregated standardized business performance information from one or more businesses, an entire industry, and the like. For example, the converted business performance information may be used to predict the future performance of a business or industry in the event that interest rates decline.

After the benchmarking and analysis module 1725 has completed the data analysis, the control module 1722 causes the analysis results to be stored in the storage module 1723 in association with that submitter's business performance information. Then, the control module 1722 invokes the report/alert generator module 1726 which generates at least one benchmarking performance report based at least in part on the results generated by the benchmarking and analysis module 1725. The benchmarking performance report may include a variety of information related to the business performance and/or operational performance of the business, such as, for example, a summary of key financial metrics (e.g., total revenue, net income, the debt-to-equity ratio, goods sold per store, etc.), tables or charts detailing the historical performance of various financial metrics, a comparison of various financial metrics with financial metrics for one or more previous periods or cycles, benchmark comparisons of various financial metrics to the corresponding financial metrics of peer businesses or an industry standard, and the like.

The benchmark performance report further may include one or more alert indicators associated with certain performance report items, where the alert indicators are intended to cause a reviewer of the benchmarking performance report to analyze the corresponding performance report items in greater detail. The alert indicator may be used to identify those performance report items that reflect positively on the performance of the business, as well as those performance report items that reflect negatively on business performance. In at least one embodiment, an alert indicator may be used when a change in the performance metric from a previous period exceeds or fails to exceed a certain threshold or when the performance metric varies from a predetermined value by a certain threshold, where the predetermined value may represent an industry standard value or a target value prescribed by, for example, the business or a lender as part of a loan agreement with the business.

With continued reference to FIG. 17, after the control module 1722 determines that the report/alert generator module 1726 has finished processing, the control module 1722 causes the results to be stored in the storage module 1723 in association with that submitter's business performance data. Then, the control module 1722 causes the communications module 1728 to send a message to the submitter indicating that all data processing and analysis has been completed, or if the submitter has been waiting, the control module 1722 invokes the dashboard module 1727 to display the benchmarking dashboard.

When the submitter logs back into the business performance information benchmarking data center computer system 1720 through the authentication module 1721, the control module 1722 sends a signal to the dashboard module 1727 to display the benchmarking dashboard including the results of the conversion module 1724, the benchmarking and analysis module 1725 and the report/alert generator module 1726. All viewer controlled interactive functionality is provided through the dashboard module 1727—for example, changing periods of display, changing the graph portion, uploading data for subsequent periods and navigating around the dashboard functions. When a viewer selects functionality not specifically available from the dashboard module, such as, for example, displaying industry quartile performance data on the graph portion along with the submitter's and industry average performance data, the dashboard module 1727 may cause the control module 1722 to call one or more of the other modules, such as the storage module 1723, the conversion module 1724 and the benchmarking and analysis module 1725. Also, the dashboard module 1727 may cause the control module 1722 to call the report/alert generator module 1726 to permit the submitter to set various alerts as discussed herein. In various embodiments, changes made by the submitter through the dashboard module 1727 are stored in the storage module 1723.

The submitter may also select a data export function from the benchmarking dashboard to export the benchmarked data to a various external software programs such as, for example, a spread sheet program, a credit analysis program or other suitable program. In doing so, the control module 1722 will cause the conversion module 1723 to perform the appropriate conversion specified by the user. Then, the exported data may appear as a download link displayed by the dashboard module 1726, or alternatively, the control module 1722, may cause the communication module 1727 to send an electronic mail message to a recipient designated by the submitter that includes the exported benchmarking data as a file attachment.

The submitter may instruct the data center computer system 1720 to perform various automated messaging functions. For example, for the submitter may request to be automatically notified by the system 1720 when it is time to upload the latest period's business performance information. A submitter may program the data center computer system 1720 to perform various performance information monitoring functions. For example, a submitter may desire to have the data center computer system 1720 monitor its business performance information in accordance with one or more financial metrics, and to program threshold alerts which cause an automated message to be sent to the submitter if the value of the one or more metrics falls below or above a threshold amount, or alternatively, if a metric for the industry average falls below or exceeds a certain value or percentage. In this embodiment, alert thresholds will be stored in the storage module 1723. Periodically, or upon data uploads, the control module 1722 will interrogate the business performance data of authorized submitters to determine compliance with any alert thresholds. If, the control module 1722 in combination with the alerts/variance generator module 1725 determines that any of the metrics has exceeded or failed to exceed any alert thresholds, the control module 1722 will invoke the communications module 1728 to send a message in accordance with that submitter's previously stored instructions. Through the use of these automated messaging functions, submitters may rely on the data center computer system 1720 to perform several event driven and analytical operations enhancing the value of the system to the participants.

As discussed herein, in various embodiments, other parties may interact with the system besides submitter business to view benchmarking information of a particular group of companies, as in the context of entities 520, 525, 530 and 535 discussed in FIG. 5. In such an example, the various entities will be explicitly authorized by each submitter business, or may be implicitly authorized through pre-existing contractual relationships with these entities' customers. In such a case, a user will log into the system through the authentication module 1721 in a manner analogous to that for submitter businesses. The user will provide identification credentials to the authentication module 1721 which are compared against previously stored identification information stored in the storage module 1723. The control module 1722 will then determine a list of contributing companies whose benchmarked business performance information may be viewed by the particular affiliated user. The control module 1722 will then cause the dashboard module 1726 to generate a benchmarking dashboard that visualizes the results of benchmarking for the group of companies whose information the user may view. In various embodiments, the user may then benchmark the information for any of the companies on the list against the remaining companies on the list or against other aggregate industry information stored by the storage module 1723. The user may also perform other functions such as functions provided by the communications module 1727, dashboard module 1726, alert/variance generator module 1725 and administration module 1728 that are available to submitter businesses as discussed herein. For example, through the dashboard module 1726 and alert/variance generator module 1725, the user may set up a variance threshold to be stored in the storage module 1723 and periodically checked by the control module 1722. When the control module 1722 determines that the threshold variance has been met, the communications module 1727 may be automatically invoked to send a message to the user as discussed herein.

In yet further embodiments, business entities may interact with the system strictly for the purpose of obtaining customizable aggregate business performance formation for an industry, region or subsection of an industry without viewing or obtaining any benchmark information on a particular company. Such a user will access the system through the network 1710 and will register an interest in receiving aggregate industry information in a manner similar to that of a submitter business registering an interest in receiving benchmarking services. In such an instance, the user will interface with the system 1720 through the authentication module 1721. If this is the user's first interaction with the system 1720, the authentication module will load a page from the storage module 1723 that allows the user to specify various data fields that identify the user as well as industries for which the user is interested in obtaining aggregate information. The control module 1722 will then cause this information to be stored in the storage module 1723 and will check to see if aggregate information is currently available for the industry or industries specified by the user. If not, the control module 1722 displays a page from the storage module 1723 informing the user that aggregate information is not currently available but that a notification message will be sent to the email address provided by the user when such information is available. Otherwise, if the desired information is currently available, the user will be provided with a page from the storage module 1723 that permits the user to subscribe to the system to view the requested information by supplying a credit card number. In various embodiments, the user will subscribe at the time of viewing by providing a credit card number as described herein. However, in various other embodiments, the user will be invoiced, such as, for example, on a quarterly or annual basis. The specific billing arrangement is not critical to the invention. Once the user has submitted this information, the control module 1722 invokes the communication module 1727 to contact an outside credit card processing system to receive credit authorization. Once received, the system 1720 may operate according to various different procedures. In one embodiment, the control module 1722 may display a page from the storage module 1723 containing a list of available products, such as a list of reports for the particular industry of interest to the user, or a list of services, such as a dashboard interface that may be subscribed to by the user. In the former case, upon selection of a report, the control module 1722 will load a page from the storage module 1723 operable to permit the user to download the desired report from the storage module 1723. In the latter case, the control module 1722 will invoke the dashboard module 1726 to present a generic dashboard to the user that allows the user to view aggregated industry information for a particular industry or all available industries, or aggregated information based on attributes selected by the user, such as, for example, geographic, size, revenue, etc., without regard to industry, depending on the type of service selected by the user. In this case, other system functionality, such as that provided by the communications module 1727, dashboard module 1726 and alert/variance generator module 1725 may be available to the user as discussed herein, but without the ability to benchmarking a particular company against the aggregated data. Rather, this user's services will be limited to examining various aspects of business performance associated with a single industry, multiple industries or all available industries as specified by the user and based on either an industry code or other user specified parameter, such as, for example, geographic, size, revenue, etc., without regard to industry.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method for performing benchmarking of business performance information comprising the steps of:
generating at least one business performance report based on data associated with a submitter business on a computer system;
uploading the at least one business performance report to a data center computer system via a communications network including uploading at least one classification code for the submitter business;
converting, using an automated process executed by the data center computer system, the at least one business performance report from a first data format to a second data format;
adding data in either the first data format or the second data format to aggregated data for other submitter businesses; and
benchmarking information in the second data format against the aggregated data based on the at least one classification code.

2. The method according to claim 1, further comprising displaying the results of the benchmarking in a format viewable by an authorized agent of the submitter business via the communications network.

3. The method according to claim 1, wherein generating at least one business performance report comprises generating at least one business performance report using an accounting software program and saving the report as at least one electronic file.

4. The method of claim 3, the step of uploading the at least one business performance report comprising logging into an Internet website associated with the data center computer system through a secure connection and uploading the at least one electronic file to the data center computer system.

5. The method of claim 3, wherein the step of generating at least one business performance report comprises generating a report based on data from a business performance period.

6. The method of claim 3, wherein the step of generating at least one business performance report comprises generating a trial balance report.

7. The method of claim 1, the step of converting the at least one business performance report from a first format to a second format comprising converting the at least one business performance report from a submitter-defined format to a standardized format.

8. The method of claim 7, the step of converting the at least one business performance report further comprises analyzing the business performance data in accordance with at least one financial metric.

9. The method of claim 8, wherein the at least one financial metric is chosen from the group consisting of generally accepted accounting metrics and operational metrics, including but not limited to revenue growth, gross margins, EBIT and EBITDA margins, cash position, cash flow generation, debt to total capitalization ratio, funded debt to EBITDA ratio, and interest coverage metrics.

10. The method according to claim 8, wherein benchmarking comprises generating a business performance report in the second data format listing the at least one financial metric, the at least one financial metric having a value for the submitter business and a value taken from the aggregated business performance data.

11. The method according to claim 10, wherein the aggregated business performance data comprises data selected from the group consisting of aggregated data from businesses other than the submitter business and aggregated data including data from the submitter business.

12. The method according to claim 10, wherein benchmarking further comprises generating an interactive benchmarking dashboard.

13. The method according to claim 12, wherein generating an interactive benchmarking dashboard comprises generating an interactive benchmarking dashboard having values for the at least one financial metric and a graph portion.

14. The method according to claim 13, wherein the values for the at least one financial metric are operable to be plotted in the graph portion.

15. The method according to claim 14, wherein the graph portion is operable to plot values for the at least one financial metric for a viewer selected time period.

16. The method according to claim 14, wherein a type of graph may be selected from a list of graph types by a viewer of the dashboard.

17. The method according to claim 14, wherein the graph portion is operable to plot values for the at least one financial metric for only the submitter business.

18. The method according to claim 14, wherein the graph portion is operable to plot values for the at least one financial metric for the submitter business and the aggregated data simultaneously.

19. The method according to claim 12, wherein generating an interactive benchmarking dashboard comprises generating an interactive benchmarking dashboard having a time period control for controlling the time period over which business performance information is benchmarked.

20. The method according to claim 12, wherein generating an interactive benchmarking dashboard comprises generating an interactive benchmarking dashboard having a peer group control module.

21. The method according to claim 20, wherein the peer group control module is operable to truncate the set of businesses whose information contributes to the aggregate business performance information based on one or more adjustable parameters.

22. The method according to claim 21, wherein the one or more adjustable parameters are selected from the group consisting of geographic location, state, number of employees, amount of assets, amount of net income, amount of revenue, net margin trend, debt/equity ratio trend, current ratio trend, net income trend and other available metrics.

23. The method according to claim 13, the step of benchmarking comprising generating one or more alerts if the difference between the values for the at least one financial metric exceed or fail to exceed a predetermined threshold set by a viewer of the business performance report.

24. The method according to claim 23, wherein generating an alert comprises an option selected from the group consisting of sending an email message to the submitter business, generating an alert on the benchmarking dashboard, and combinations thereof.

25. The method according to claim 1, wherein the at least one classification code is a code selected from the group consisting of a Standard Industrial Classification (SIC) code and a North American Industry Classification System (NAICS) code.

26. A method for benchmarking business performance data of a submitter business against other aggregated business performance data of businesses in the same industry comprising:
generating, with a software program executing on a computer system, at least one business performance report comprising business performance data of a submitter business in a first data format;
using a graphical user interface, uploading the at least one report to a data center computer system via the Internet including uploading at least one classification code for the submitter business;
converting, using an automated process executed by the data center computer system, the at least one report from the first data format into a second data format;
adding data in either the first data format or the second data format to aggregated data for other submitter businesses; and
benchmarking information in the second data format against the aggregated data based on the at least one classification code.

27. The method according to claim 26, further comprising displaying the results of the benchmarking to viewers authorized by the submitter business via the Internet.

28. The method according to claim 26, the step of generating at least one business performance report comprising generating a trial balance report.

29. The method according to claim 26, the step of generating at least one business performance report comprising saving the report as an electronic file.

30. The method according to claim 29, the step of uploading the at least one report comprising uploading the electronic file.

31. The method according to claim 26, using a graphical user interface comprising using a web browser software application.

32. The method according to claim 26, the step of converting the at least one report from the first data format into a second data format comprising converting the report from a submitter-defined format to a standardized format.

33. The method according to claim 32, the step of converting the at least one report from the submitter-defined format to a standardized format comprising performing a mapping from the submitter-defined format to the standardized format using a predetermined mapping function associated with the submitter-defined format.

34. The method according to claim 26, the step of converting further comprising analyzing the business performance data in accordance with at least one financial metric.

35. The method of claim 34, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, interest coverage metrics, and other generally accepted accounting metrics.

36. The method according to claim 34, wherein benchmarking comprises generating a business performance report in the second data format listing the at least one financial metric, the at least one financial metric having a value for the submitter business and a value taken from the aggregated business performance data.

37. The method according to claim 36, wherein the aggregated business performance data comprises data selected from the group consisting of aggregated data from businesses other than the submitter business and aggregated data including data from the submitter business

38. The method according to claim 36, wherein benchmarking further comprises generating an interactive benchmarking dashboard.

39. The method according to claim 38, wherein generating an interactive benchmarking dashboard comprises generating an interactive benchmarking dashboard having values for the at least one financial metric and a graph portion.

40. The method according to claim 39, wherein the values for the at least one financial metric are operable to be plotted in the graph portion.

41. The method according to claim 39, wherein the graph portion is operable to plot values for the at least one financial metric for a viewer selected time period.

42. The method according to claim 39, wherein a type of graph may be selected from a list of graph types by a viewer of the dashboard.

43. The method according to claim 39, wherein the graph portion is operable to plot values for the at least one financial metric for only the submitter business.

44. The method according to claim 39, wherein the graph portion is operable to plot values for the at least one financial metric for the submitter business and the aggregated data simultaneously

45. The method according to claim 38, wherein generating an interactive benchmarking dashboard comprises generating an interactive benchmarking dashboard having a time period control for controlling the time period over which business performance information is benchmarked.

46. The method according to claim 38, wherein generating an interactive benchmarking dashboard comprises generating an interactive benchmarking dashboard having a peer group control module.

47. The method according to claim 46, wherein the peer group control module is operable to filter the set of businesses whose information contributes to the aggregate business performance information based on one or more adjustable parameters.

48. The method according to claim 47, wherein the one or more parameters are selected from the group consisting of geographic location, state, number of employees, amount of assets, amount of net income, amount of revenue, net margin trend, debt/equity ratio trend, current ratio trend, net income trend, and other available metrics.

49. The method according to claim 38, the step of benchmarking comprising generating one or more alerts if the difference between the values for the at least one financial metric exceed or fail to exceed a predetermined threshold set by a viewer of the business performance report.

50. The method according to claim 49, wherein generating an alert comprises an option selected from the group consisting of sending an email message to the submitter business and/or to the requester business, generating an alert on the benchmarking dashboard, and combinations thereof.

51. The method according to claim 26, wherein the classification code comprises a code selected from the group consisting of an SIC code and an NAICS code.

52. A system for automated benchmarking of a submitter business's business performance information comprising:
at least one data center computer system configured to:
operate at least one Internet web site displaying one or more Internet web pages;
receive business performance information associated with a submitter business via data upload of at least one business performance information file from the submitter business over the Internet, the at least one business performance information file formatted in a first data format and including at least one classification code for the submitter business;
using software instructions executing on the data center computer system, convert the at least one business performance report from a first data format into a second data format;
add data in either the first data format or the second data format to aggregated performance data of other businesses;
perform benchmarking of the converted business performance report the based on the at least one classification code; and
display the at least one business performance report including results of the benchmarking in the second data format over the Internet to persons authorized by the submitter business.

53. The system of claim 52, wherein the at least one business performance information file comprises a trial balance report stored as an electronic file.

54. The system of claim 52, wherein the data center computer system is configured to convert the at least one business performance report from a submitter-defined format to a standardized format.

55. The system of claim 54, wherein the data center computer system is configured to convert the at least one business performance report from a submitter-defined format to a standardized format using a predetermined mapping function associated with the submitter-defined format and based on values of the one or more submitter-defined fields.

56. The system of claim 52, wherein the data center computer system is configured to analyze the business performance data in accordance with at least one financial metric.

57. The system of claim 52, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

58. The system of claim 56, wherein the data center computer system is configured to perform benchmarking by generating a business performance report in the second data format listing the at least one financial metric, the at least one financial metric having a value for the submitter business and a value taken from the aggregate business performance data based on the at least one classification code.

59. The system of claim 58, wherein the aggregated business performance data comprises data selected from the group consisting of aggregated data from businesses other than the submitter business and aggregated data including data from the submitter business.

60. The system of claim 58, wherein the data center computer system is further configured to generate an interactive benchmarking dashboard.

61. The system of claim 60, wherein the data center computer system is further configured to generate an interactive benchmarking dashboard having values for the at least one financial metric and a graph portion.

62. The system of claim 61, wherein the values for the at least one financial metric are operable to be plotted in the graph portion.

63. The method according to claim 61, wherein the graph portion is operable to plot values for the at least one financial metric for a viewer selected time period.

64. The method according to claim 61, wherein a type of graph may be selected from a list of graph types by a viewer of the dashboard.

65. The method according to claim 61, wherein the graph portion is operable to plot values for the at least one financial metric for only the submitter business.

66. The method according to claim 61, wherein the graph portion is operable to plot values for the at least one financial metric for the submitter business and the aggregated data simultaneously.

67. The system of claim 60, wherein the data center computer system is further configured to generate an interactive benchmarking dashboard having a time period control for controlling the time period over which business performance information is benchmarked.

68. The system of claim 60, wherein the data center computer system is further configured to generate an interactive benchmarking dashboard having a peer group control module.

69. The system of claim 68, wherein the peer group control module includes controls for filtering the set of businesses whose information contributes to the aggregate business performance information based on one or more adjustable parameters.

70. The system of claim 69, wherein the one or more parameters are selected from the group consisting of geographic location, state, number of employees, amount of assets, amount of net income, amount of revenue, net margin trend, debt/equity ratio trend, current ratio trend, net income trend and other available metrics.

71. The system of claim 60, wherein the data center computer system is further configured to generate one or more alerts if the difference between the values for the at least one financial metric exceed or fail to exceed a predetermined threshold set by a viewer of the business performance report.

72. The system of claim 71, generating one or more alerts comprising an option from the group consisting of sending an email message to the submitter business and/or to the requestor business, generating an alert on the benchmarking dashboard, and combinations thereof.

73. The system of claim 52, wherein the classification code is a code selected from the group consisting of a SIC code and an NAICS code.

74. In an environment comprising a plurality of submitter businesses, each submitter business associated with at least one submitter business computer system and each submitter business classified by at least one classification code, and a data center computer system, the at least one submitter business communicating with the data center computer system via a communications network, a system for benchmarking business performance information of a submitter business against aggregated business performance information based on the at least one classification code, the system comprising:
a data center computer system comprising:
means for electronically receiving over a communications network at least one business performance information file associated with a submitter business and at least one classification code for the submitter business, the at least one business performance information file in a first data format;
automated means for converting the at least one business performance information file into a second data format;
automated means for aggregating data from the at least one business performance information file with previously stored aggregated data of other businesses;
automated means for benchmarking data in the second data format against the aggregated data based on the at least one classification code; and
means for selectively displaying information contained in the at least one business performance information file via the communications network based on instructions from the submitter business.

75. The system of claim 74, wherein the means for electronically receiving at least one business performance information file comprises means for presenting an interactive file upload web page in a web browser window on the submitter business' computer system to facilitate transfer of the at least one business performance information file to the data center computer system.

76. The system of claim 74, wherein the at least one business performance information file comprises a trial balance worksheet saved as an electronic file.

77. The system of claim 74 wherein the automated means for converting the at least one business performance information file into a second data format comprises means for converting the business performance information file from a submitter-defined format to a standardized format.

78. The system of claim 77, wherein the means for converting the report from a submitter-defined format to a standardized format comprises a software-based mapping function for converting the data file from the specific submitter-defined format to the standardized format using a predetermined mapping function associated with the submitter-defined format.

79. The system of claim 74, wherein the means for converting the at least one business performance information file into a second data format comprises software instructions for analyzing the business performance data in accordance with at least one financial metric.

80. The system of claim 79, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

81. The system of claim 79, wherein the means for benchmarking comprises means for generating a business performance report in the second data format listing the at least one financial metric, the at least one financial metric having a value for the submitter business and a value taken from the aggregate business performance data based on the at least one classification code.

82. The system of claim 81, wherein the aggregated business performance data comprises data selected from the group consisting of aggregated data from businesses other than the submitter business and aggregated data including data from the submitter business.

83. The system of claim 81, wherein means for benchmarking further comprises means for generating an interactive benchmarking dashboard.

84. The system of claim 83, wherein means for generating an interactive benchmarking dashboard comprises means for generating an interactive benchmarking dashboard having values for the at least one financial metric and a graph portion.

85. The system of claim 84, wherein the values for the at least one financial metric are operable to be plotted in the graph portion.

86. The system of claim 84, wherein the graph portion is operable able to plot values for the at least one financial metric for a viewer selected time period.

87. The system of claim 84, wherein a type of graph may be selected from a list of graph types by a viewer of the dashboard.

88. The system of claim 84, wherein the graph portion is operable to plot values for the at least one financial metric for only the submitter business.

89. The system of claim 84, wherein the graph portion is operable to plot values for the at least one financial metric for the submitter business and the aggregated data simultaneously.

90. The system of claim 83, wherein means for generating an interactive benchmarking dashboard comprises means for generating an interactive benchmarking dashboard having a time period control for controlling the time period over which business performance information is benchmarked.

91. The system of claim 83, wherein means for generating an interactive benchmarking dashboard comprises means for generating an interactive benchmarking dashboard having a peer group control module.

92. The system of claim 91, wherein the peer group control module is operable to truncate the set of businesses whose information contributes to the aggregate business performance information based on one or more adjustable parameters.

93. The system of claim 92, wherein the one or more parameters are selected from the group consisting of geographic location, state, number of employees, amount of assets, amount of net income, amount of revenue, net margin trend, debt/equity ratio trend, current ratio trend, net income trend and other available metrics.

94. The system of claim 83, wherein the means for benchmarking comprising means for generating one or more alerts if the difference between the values for the at least one financial metric exceed or fail to exceed a predetermined threshold set by a viewer of the business performance report.

95. The system of claim 94, means for generating an alert comprising means for performing an option from the group consisting of sending an email message to the submitter business, generating an alert on the benchmarking dashboard and combinations thereof.

96. The system of claim 74, wherein the classification code comprises a code selected from the group consisting of an SIC code and an NAICS code.

97. A method for adding submitter businesses to a business performance information benchmarking network comprising:
sending an electronic message over a communications network to a business inviting the business to participate in the business performance information benchmarking network, the message including an electronic link to a data center computer system;
after selection of the link by a representative of the submitter business, receiving a business performance information file at the data center computer system along with at least one classification code for the submitter business over the communications network;
converting data in the business performance information file from a first data format to a second data format;
adding data in either the first data format or the second data format to the aggregated data from other businesses;
benchmarking the data in the second data format against the aggregated data based on the at least one classification code;
enabling the business performance data in the second data format including the results of the benchmarking to be viewed via the network based on instructions received from the submitter business.

98. The method of claim 97, wherein the step of receiving a business performance information file comprises receiving a business performance information file based on data from a business performance period.

99. The method of claim 97, wherein the step of receiving a business performance information file comprises receiving a trial balance report.

100. The method of claim 97, the step of converting the business performance information file a first data format to a second data format comprises converting the at least one business performance information file from a submitter-defined format to a standardized format.

101. The method of claim 100, the step of converting the at least one business performance information file further comprises analyzing the data in the business performance information file in accordance with at least one financial metric.

102. The method of claim 101, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

103. The method of claim 101, wherein benchmarking comprises generating a business performance report in the second data format listing the at least one financial metric, the at least one financial metric having a value for the submitter business and a value taken from the aggregate business performance information of the other businesses having the same classification code.

104. The method of claim 103, wherein the aggregated business performance data comprises data selected from the group consisting of aggregated data from businesses other than the submitter business and aggregated data including data from the submitter business.

105. The method of claim 103, wherein benchmarking further comprises generating an interactive benchmarking dashboard.

106. The method of claim 105, wherein generating an interactive benchmarking dashboard comprises generating an interactive benchmarking dashboard having values for the at least one financial metric and a graph portion.

107. The method of claim 106, wherein the values for the at least one financial metric are operable to be plotted in the graph portion.

108. The method according to claim 106, wherein the graph portion is operable to plot values for the at least one financial metric for a viewer selected time period.

109. The method according to claim 106, wherein a type of graph may be selected from a list of graph types by a viewer of the dashboard.

110. The method according to claim 106, wherein the graph portion is operable to plot values for the at least one financial metric for only the submitter business.

111. The method according to claim 106, wherein the graph portion is operable to plot values for the at least one financial metric for the submitter business and the benchmarked data simultaneously.

112. The method of claim 105, wherein generating an interactive benchmarking dashboard comprises generating an interactive benchmarking dashboard having a time period control for controlling the time period over which business performance information is benchmarked.

113. The method of claim 105, wherein generating an interactive benchmarking dashboard comprises generating an interactive benchmarking dashboard having a peer group control module.

114. The method of claim 113, wherein the peer group control module is operable to filter the set of businesses whose information contributes to the aggregate business performance information based on one or more adjustable parameters.

115. The method of claim 114, wherein the one or more parameters are selected from the group consisting of geographic location, state, number of employees, amount of assets, amount of net income, amount of revenue, net margin trend, debt/equity ratio trend, current ratio trend, net income trend, and other available metrics.

116. The method of claim 105, the step of benchmarking comprising generating one or more alerts if the difference between the values for the at least one financial metric exceed of fail to exceed a predetermined threshold set by a viewer of the business performance report.

117. The method of claim 106, generating an alert comprising an action selected from the group consisting of sending an email message to the submitter business and/or to the requestor business, setting an alert on the benchmarking dashboard and combinations thereof.

118. The method of claim 97, wherein the at least one classification code comprises a code selected from the group consisting of an SIC code and an NAICS code.

119. In a data center computer system, a computer readable storage medium containing computer readable instructions executable by a processor, the instructions configured to enable a submitter business to benchmark business performance information against aggregated business performance information for other business in the same industry as the submitter business comprising:
instructions for receiving a data upload comprising a file containing business performance data corresponding to a submitter business in the form of a business performance information file in a first data format including at least one classification code for the submitter business;
instructions for converting the business performance data in the business performance information file into a second data format;
instructions for adding the business performance data to aggregated business performance data for other businesses;
instructions for benchmarking the business performance data in the second data format against the aggregated business performance data based on the at least one classification code;
instructions for generating a business performance report including the business performance data in the second data format and the results of the benchmarking; and
instructions for displaying the business performance report to the submitter business.

120. The computer readable storage medium of claim 119, the instructions for converting the business performance data in the business performance information file into a second data format comprising instructions for converting a trial balance report from a submitter-defined format to a standardized format.

121. The computer readable storage medium of claim 120, the instructions for converting the trial balance report from a submitter-defined format to a standardized format comprising instructions for performing a mapping function from the specific submitter-defined format to the standardized format using a predetermined mapping function associated with the submitter-defined format.

122. The computer readable storage medium of claim 119, the instructions for converting the business performance data in the business performance information file into a second data format comprising instructions for analyzing the business performance data in accordance with at least one financial metric.

123. The computer readable storage medium of claim 122, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

124. The computer readable storage medium of claim 122, wherein the instructions for generating a business performance report comprise instructions for generating a business performance report having the at least one financial metric, the at least one financial metric having a value for the submitter business and a value taken from the aggregate business performance data based on the at least one classification code.

125. The computer readable storage medium of claim 124, wherein the aggregated business performance data comprises data selected from the group consisting of aggregated data from businesses other than the submitter business and aggregated data including data from the submitter business.

126. The computer readable storage medium of claim 124, wherein instructions for benchmarking further comprise instructions for generating an interactive benchmarking dashboard.

127. The computer readable storage medium of claim 126, wherein instructions for generating an interactive benchmarking dashboard comprise instructions for generating an interactive benchmarking dashboard having values for the at least one financial metric and a graph portion.

128. The computer readable storage medium of claim 124, wherein the values for the at least one financial metric are operable to be plotted in the graph portion.

129. The computer readable storage medium of claim 127, wherein instructions for generating an interactive benchmarking dashboard having values for the at least one financial metric and a graph portion comprise instructions for enabling a viewer to select a time period for which values are plotted.

130. The computer readable storage medium of claim 127, wherein instructions for generating an interactive benchmarking dashboard having values for the at least one financial metric and a graph portion comprise instructions for enabling a viewer of the dashboard to select a type of graph from a list of available graph types.

131. The computer readable storage medium of claim 127, wherein instructions for generating an interactive benchmarking dashboard having values for the at least one financial metric and a graph portion comprise instructions for plotting values for the at least one financial metric for only the submitter business.

132. The computer readable storage medium of claim 127, wherein instructions for generating an interactive benchmarking dashboard having values for the at least one financial metric and a graph portion comprise instructions for plotting values for the at least one financial metric for the submitter business and the aggregated data.

133. The computer readable storage medium of claim 126, wherein instructions for generating an interactive benchmarking dashboard comprise instructions for generating an interactive benchmarking dashboard having a time period control for controlling the time period over which business performance information is benchmarked.

134. The computer readable storage medium of claim 126, wherein instructions for generating an interactive benchmarking dashboard comprise instructions for generating an interactive benchmarking dashboard having a peer group control module.

135. The computer readable storage medium of claim 134, wherein the peer group control module is operable to filter the set of businesses whose information contributes to the aggregate business performance information based on one or more adjustable parameters.

136. The computer readable storage medium of claim 135, wherein the one or more parameters are selected from the group consisting of geographic location, state, number of employees, amount of assets, amount of net income, amount of revenue, net margin trend, debt/equity ratio trend, current ratio trend, net income trend, and other available parameters.

137. The computer readable storage medium of claim 126, instructions for benchmarking comprising instructions for generating one or more alerts if the difference between the values for the at least one financial metric exceed or fail to exceed a predetermined threshold set by a viewer of the business performance report.

138. The computer readable storage medium of claim 137, instructions for generating an alert comprising instructions for performing an action selected from the group consisting of sending an email message to the submitter business and/or to the requestor business, generating an alert on the benchmarking dashboard and combinations thereof.

139. The computer readable storage medium of claim 119, wherein the at least one classification code comprises a code selected from the group consisting of an SIC code and an NAICS code.

140. In a data center computer system, a computer readable storage medium containing computer readable instructions executable by a processor, the instructions configured to enable a submitter business to benchmark business performance information against aggregated business performance information for other comprising:
instructions for receiving a request to perform benchmarking of a company's business performance data accessible by the data center computer system;
instructions for benchmarking the business performance data against aggregated business performance accessible by the data center computer system based on at least one classification code associated with the company;
instructions for generating a business performance report including results of the benchmarking; and
instructions for displaying the business performance report to the interested party.

141. The computer readable storage medium of claim 140, the instructions for benchmarking further comprising for instructions for analyzing the business performance data in accordance with at least one financial metric.

142. The computer readable storage medium of claim 141, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

143. The computer readable storage medium of claim 142, wherein the instructions for generating a business performance report comprise instructions for generating a business performance report having the at least one financial metric, the at least one financial metric having a value for the company and a value taken from the aggregated business performance data based on the at least one classification code.

144. The computer readable storage medium of claim 143, wherein the aggregated business performance data comprises data selected from the group consisting of aggregated data from businesses other than the company and aggregated data including data from the company.

145. The computer readable storage medium of claim 143, wherein instructions for benchmarking further comprise instructions for generating an interactive benchmarking dashboard.

146. The computer readable storage medium of claim 145, wherein instructions for generating an interactive benchmarking dashboard comprise instructions for generating an interactive benchmarking dashboard having values for the at least one financial metric and a graph portion.

147. The computer readable storage medium of claim 146, wherein the values for the at least one financial metric are operable to be plotted in the graph portion.

148. The computer readable storage medium of claim 146, wherein instructions for generating an interactive benchmarking dashboard having values for the at least one financial metric and a graph portion comprise instructions for enabling a viewer to select a time period for which values are plotted.

149. The computer readable storage medium of claim 146, wherein instructions for generating an interactive benchmarking dashboard having values for the at least one financial metric and a graph portion comprise instructions for enabling a viewer of the dashboard to select a type of graph from a list of available graph types.

150. The computer readable storage medium of claim 146, wherein instructions for generating an interactive benchmarking dashboard having values for the at least one financial metric and a graph portion comprise instructions for plotting values for the at least one financial metric for only the submitter business.

151. The computer readable storage medium of claim 146, wherein instructions for generating an interactive benchmarking dashboard having values for the at least one financial metric and a graph portion comprise instructions for plotting values for the at least one financial metric for the submitter business and the aggregated data.

152. The computer readable storage medium of claim 145, wherein instructions for generating an interactive benchmarking dashboard comprise instructions for generating an interactive benchmarking dashboard having a time period control for controlling the time period over which business performance information is benchmarked.

153. The computer readable storage medium of claim 145, wherein instructions for generating an interactive benchmarking dashboard comprise instructions for generating an interactive benchmarking dashboard having a peer group control module.

154. The computer readable storage medium of claim 153, wherein the peer group control module is operable to filter the set of businesses whose information contributes to the aggregate business performance information based on one or more adjustable parameters.

155. The computer readable storage medium of claim 154, wherein the one or more parameters are selected from the group consisting of geographic location, state, number of employees, amount of assets, amount of net income, amount of revenue, net margin trend, debt/equity ratio trend, current ratio trend, net income trend, and other available parameters.

156. The computer readable storage medium of claim 145, instructions for benchmarking comprising instructions for generating one or more alerts if the difference between the values for the at least one financial metric exceed or fail to exceed a predetermined threshold set by a viewer of the business performance report.

157. The computer readable storage medium of claim 156, instructions for generating an alert comprising instructions for performing an action selected from the group consisting of sending an email message to the submitter business and/or to the requester business, generating an alert on the benchmarking dashboard and combinations thereof.

158. The computer readable storage medium of claim 140, wherein the at least one classification code comprises a code selected from the group consisting of an SIC code and an NAICS code.

159. In an environment comprising a data center computer system and a database containing aggregated business performance information on a plurality of companies that is accessible by the computer system, a system for generating at least one business performance report based on the aggregated business performance information comprising:
means for providing a graphical user interface;
means for accepting a request for a business performance report through the graphical user interface;
means for searching the database for aggregate business performance information based on the request; and
means for displaying the results of the search as at least one business performance report in the graphical user interface.

160. The system of claim 159, wherein the means for searching the database comprises means for searching the database for aggregated business performance information based on at least one financial metric.

161. The system of claim 160, wherein the at least one financial metric is chosen from the group consisting of generally accepted accounting metrics and operational metrics, including but not limited to revenue growth, gross margins, EBIT and EBITDA margins, cash position and cash flow generation, debt to total capitalization ratio, funded debt to EBITDA ratio, and interest coverage metrics.

162. The system of claim 160, wherein the means for providing a graphical user interface comprises means for generating an interactive dashboard, and means for displaying the results of the search comprises means for displaying the results through the interactive dashboard.

163. The system of claim 162, wherein the means for displaying the results through the interactive dashboard comprises means for displaying a value for at least one financial metric and a graph portion.

164. The system of claim 163, wherein the value for the at least one financial metric is operable to be plotted in the graph portion.

165. The system of claim 163, wherein the graph portion is operable able to plot values for the at least one financial metric for a viewer selectable time period.

166. The system of claim 163, wherein a type of graph may be selected by a viewer from a list of graph types by a viewer of the dashboard.

167. The system of claim 162, wherein means for generating an interactive dashboard comprises means for generating an interactive dashboard having an aggregate business performance information control module.

168. The system of claim 167, wherein the aggregate business performance information control module is operable to truncate the set of businesses whose information contributes to the aggregate business performance information of the displayed results based on one or more adjustable parameters.

169. The system of claim 168, wherein the one or more parameters are selected from the group consisting of classification code, geographic location, state, number of employees, amount of assets, amount of net income, amount of revenue, net margin trend, debt/equity ratio trend, current ratio trend, net income trend and other available metrics.

170. The system of claim 169, wherein the classification code comprises at least one code selected from the group consisting of an SIC code and an NAICS code.

171. The system of claim 162, wherein the means for generating an interactive dashboard comprising means for automatically generating one or more alerts if the difference between the values for the at least one financial metric exceed or fail to exceed a predetermined threshold set by a viewer of the business performance report.

172. The system of claim 171, wherein the means for generating an alert comprising means for performing an option from the group consisting of sending an email message to a user of the system, generating an alert on the benchmarking dashboard and combinations thereof.
